(19) United States
(12) Patent Application Publication
(10) Pub. No.: US 2007/0078863 A1
(43) Pub. Date: Apr. 5, 2007

(54) Application support and maintenance system, software, database and related methods

(76) Inventor: Peter Thompson, Calgary (CA)

Correspondence Address: Ralph A. Dowell of DOWELL & DOWELL P.C., 2111 Eisenhower Ave, Suite 406, Alexandria, VA, 22314, US

(21) Appl. No.: 11/240,480

(22) Filed: Oct. 3, 2005

(51) Int. Cl. G06F 7/00

(52) U.S. Cl. 707/100

(57) ABSTRACT

One or more databases for use in computer program application support and maintenance. An inventory of computer program applications (“application inventory”) is arranged in a multilevel hierarchy having descending levels. Line of business level, application level and technical module level. A support and maintenance work authorization and authorized workgroup are set at the line of business level, and requests for work are set at the application level and below. Automatically relates business functions to computer programs to determine performance of applications within business functions. The databases also include timesheets, each timesheet having time data recorded by a skilled person in a workgroup for work on a ticket. Computer system and methods utilizing the databases are also provided.

### FIELD OF THE INVENTION

The invention relates to application support and maintenance. More particularly, the invention relates to methods, databases, system and software for use in application support and maintenance.

### BACKGROUND OF THE INVENTION

Organizations today are more and more dependent on computer software applications to perform the activities of the organization. These applications can be very complex to support and maintain. Organization leaders are often frustrated by the inability to manage the support and maintenance of computer software applications.

Companies that are large enough utilize help desks to assist users in the use of computer software applications. If it is recognized that work should be done to a computer software application, typically as a result of user feedback, then a “ticket” is often entered into a computer database for later use by information technology staff when working on the application.

Some organizations will utilize generic project management tools to assist in the management of actual work on software applications. Some organizations have built dedicated software application project management tools. These typically schedule and track the day-to-day activities of the project. Some provide assistance with the day-to-day administration of the project.

Improvement upon current tools and methods for managing application support and maintenance of computer software applications are desirable.

### SUMMARY OF THE INVENTION

In a first aspect the invention provides one or more databases for use in computer program application support and maintenance. The databases include an inventory of computer program applications of the organization (“application inventory”). The application inventory is arranged in a multilevel hierarchy having descending levels. A line of business level is a line of business within an organization that utilizes an application and the lines of business of an organization are logical divisions for business executives of the organization to utilize. An application level is an application name commonly used within the organization by users of the application. A technical module level is a technical module of the application which is recognized by support and maintenance personnel for a line of business. A support and maintenance work authorization and authorized workgroup are set at the line of business level, and requests for work are set at the application level and below. The databases also include timesheets, each timesheet having time data recorded by a skilled person in a workgroup for work on a ticket.

Each line of business may be a profit/cost center of an organization.

The database may also include an inventory of skilled people (“skills inventory”). The skilled people in the skills inventory may be assigned into workgroups, and each workgroup may be assigned to one or more lines of business.

The databases may also include a list of services that each workgroup is able to provide for its assigned one or more lines of business.

The database may also include a service level and benchmark (target time to responded resolved each service) associated with each service.

The databases may also include a start date and an end date for each assignment of a skilled person to a workgroup.

The databases may also include tickets that are assigned to skilled people. A ticket represents requested work on a computer program application of an organization as represented by its application name or a lower level name.

The databases may include estimated time to complete work on a ticket and, if completed, actual time to complete the work.

The databases may include a priority assigned to each ticket.

In a second aspect the invention provides a computer system including the databases and the system recognizes when time is entered by a person against a ticket that has a priority that does not permit the entry of time.

In a third aspect the invention provides a computer system including the databases and the system recognizes when time is entered by a person against a ticket to which the person has not been assigned.

In a fourth aspect the invention provides one or more databases for use in computer program application support and maintenance for an organization. The databases include a plurality of records organized in a descending hierarchy. The hierarchy includes a plurality of Line of Business records, each Line of Business record for a Line of Business recognized by the Board of Directors of the organization. At a lower level the hierarchy includes a plurality of application Black-Box records. Each application Black-Box record is for one of a plurality of application names that are recognized in the organization by users of computer software to which the application name refers. Each application Black-Box record is related to one or more Line of Business records. At a lower level the hierarchy includes a plurality of technical module records. Each technical module record is for one of a plurality of technical modules recognized by application support and maintenance personnel for the organization. Each technical module record is related to one or more application Black-Box records. The databases also include timesheet records, each timesheet record has time data recorded by a skilled person in a workgroup for work on a ticket.

In the databases of the fourth aspect each Line of Business may be a profit/cost center of an organization.

The databases may include a plurality of skilled person records. Each skilled person record is for a person skilled in an aspect of application support and maintenance for the organization. Each skilled person is related to a workgroup for a Line of Business of the organization.

In a fifth aspect the invention provides a computer-implemented method of supporting and maintaining computer program applications. The method includes storing in one or more databases the inventory and timesheets of the first aspect.

Other aspects of the invention will be evident from the detailed description and drawings herein.

### BRIEF DESCRIPTION OF THE DRAWINGS

For a better understanding of the present invention and to show more clearly how it may be carried into effect, reference will now be made, by way of example, to the accompanying drawings which show the preferred embodiment of the present invention and in which:

FIG. 1 is a schematic illustration of a method of configuring a database in accordance with a preferred embodiment of the present invention.

FIG. 1A is a schematic illustration of an example application inventory hierarchy for structuring a configured database in accordance with a preferred embodiment of the present invention.

FIG. 1B is a chart showing example settings for a client business function level (line of business level) in the database FIG. 1A.

FIG. 1C is a chart showing example settings of an application black-box level (application name level) in the database FIG. 1A.

FIG. 1D is a chart showing example settings for a product level (technical module level) in the database FIG. 1A.

FIG. 1E is a chart showing example description of an application importance setting at the technical module level of FIG. 1D.

FIG. 1F is a chart showing example description of a skill set settings at the technical module level of FIG. 1D.

FIG. 1G is a chart showing example application hierarchy of FIG. 1A.

FIG. 1H is an example structure of a configured application inventory database for a notional organization in accordance with a preferred embodiment of the present invention.

FIG. 1I is a chart showing example task type classifications of the types of requests that may be made with respect to an application.

FIG. 1J is a chart showing example task type that follows a single, high-level life cycle.

FIG. 1K is a chart showing example task priority ranked by the importance of a task.

FIG. 1L is a chart showing example task value that identifies the business value of a task.

FIG. IM is a chart showing example task occurrence identified by a request.

FIG. 2 is a schematic illustration of a skills inventory, database in accordance with a preferred embodiment of the present invention.

FIG. 3 is a schematic illustration of a skills inventory database of FIG. 2 and various example inputs to the database.

FIG. 3A is a chart showing example services configuration using the methods and databases identified with respect to FIGS. 2 and 3.

FIG. 3B is a chart showing example services manager configuration using the method and databases identified with respect to FIGS. 2 and 3.

FIG. 3C is a chart showing example client manager configuration using the method and databases identified with respect to FIGS. 2 and 3.

FIG. 3D is a chart showing example solution manager configuration using the method and databases identified with respect to FIGS. 2 and 3.

FIG. 3E is a chart showing example an applications support and maintenance solutions configuration using the method and databases identified with respect to FIGS. 2 and 3.

FIG. 3F is a chart showing example third party sub-contractor configuration using the method and databases identified with respect to FIGS. 2 and 3.

FIG. 3G is a chart showing example an affiliation configuration using the method and databases identified with respect to FIGS. 2 and 3.

FIG. 3H is a chart showing example an entity configuration using the method and databases identified with respect to FIGS. 2 and 3.

FIG. 3I is a chart showing example an assignment role configuration using the method and databases identified with respect to FIGS. 2 and 3.

FIG. 3J is a chart showing example a calendar configuration using the method and databases identified with respect to FIGS. 2 and 3.

FIG. 3Ji is a screen display of an example timesheet.

FIG. 3K is a chart showing example a submission periods tirnesheet configuration using the method and databases identified with respect to FIGS. 2 and 3.

FIG. 3L is a chart showing example a submission periods configuration using the method and databases identified with respect to FIGS. 2 and 3.

FIG. 3M is a chart showing example an agreement association configuration using the method and databases identified with respect to FIGS. 2 and 3.

FIG. 3N is a chart showing example a timecode category Timesheet configuration using the method and databases identified with respect to FIGS. 2 and 3.

FIG. 3P is a chart showing example a subscriber series association configuration using the method and databases identified with respect to FIGS. 2 and 3.

FIG. 3Q is a chart showing example client series association configuration using the method and databases identified with respect to FIGS. 2 and 3.

FIG. 3R is a chart showing example workgroup series association configuration using the method and databases identified with respect to FIGS. 2 and 3.

FIG. 3S is a chart showing example timecode class configuration using the method and databases identified with respect to FIGS. 2 and 3.

FIG. 3T is a chart showing example timecodes categories configuration using the method and databases identified with respect to FIGS. 2 and 3.

FIG. 3U is a chart showing example timecode description configuration using the method and databases identified with respect to FIGS. 2 and 3.

FIG. 4 is a schematic illustration a method of classifying services on application inventory in accordance with a preferred embodiment of the present invention.

FIG. 4A is a chart showing example an ASM service status configuration using the method and databases identified with respect to FIG. 4.

FIG. 4B is a chart showing example an ASM service description configuration using the method and databases identified with respect to FIG. 4.

FIG. 4C is a chart showing example an ASM service benchmark configuration using the method and databases identified with respect to FIG. 4.

FIG. 5 is a chart showing example a structure of creating a two-way work assignment in accordance with a preferred embodiment of the present invention.

FIG. 5A is a chart showing example workgroup association headcount calculation configuration using the method and databases identified with respect to FIG. 5.

FIG. 5B is a chart showing example client affiliation headcount calculation configuration using the method and databases identified with respect to FIG. 5.

FIG. 5C is a chart showing example employer affiliation headcount calculation configuration using the method and databases identified with respect to FIG. 5.

FIG. 5D is a chart showing example line of business headcount calculation configuration using the method and databases identified with respect to FIG. 5.

FIG. 5E is a chart showing example assignment of a person to a workgroup calculation configuration using the method and databases identified with respect to FIG. 5.

FIG. 5F is a chart showing example skilled resource at an hourly rate calculation configuration using the method and databases identified with respect to FIG. 5.

FIG. 5G is a chart showing example non-revenue staff providing services to other Lines of Business calculation configuration using the method and databases identified with respect to FIG. 5.

FIG. 5H is a chart showing example scheduled workgroup calculation configuration using the method and databases identified with respect to FIG. 5.

FIG. 6 is a schematic illustration of a method of corporate governance involving (authorized work) in accordance with a preferred embodiment of the present invention.

FIG. 6B is an example timesheet hours report in the form of a spreadsheet pivot table in accordance with a preferred embodiment of the present invention.

FIG. 6C is an example report of all outstanding (not resolved) problematic tickets in accordance with a preferred embodiment of the present invention.

FIG. 6Da and 6Db is an example report all applications in the top 100 percentile based on the count of problematic tickets with respect to FIG. 6C in accordance with a preferred embodiment of the present invention.

FIG. 6E is an example report of all applications in the top 100 percentile based on Benchmark Overage with respect to FIG. 6C in accordance with a preferred embodiment of the present invention.

FIG. 6F is an example steering committee report for each Line of Business showing outstanding tickets and set priorities for the tickets with respect to FIG. 6C in accordance with a preferred embodiment of the present invention.

FIG. 6G is an example chart of Backlog Analysis utilizing the configured databases in accordance with a preferred embodiment of the present invention.

FIG. 6H is an example chart of Application Black-Box Importance utilizing the configured databases in accordance with a preferred embodiment of the present invention.

FIG. 6I is an example chart of FTE Time expenditure utilizing the configured databases in accordance with a preferred embodiment of the present invention.

### DETAILED DESCRIPTION OF THE PREFERRED EMBODIMENT

This description is made with reference to a national application support and maintenance (ASM) service provider that provides ASM services to third party organizations. It is to be recognized that the examples provided herein are examples only and that the principles described are applicable generally to all manner and type of organization that use computer software applications. For example, the ASM service provider could be internal information technology staff of an organization. Consequent modification to nomenclature and record structure may be necessary from specific organization to organization without departing from the principles on which the examples provided herein are based.

This description is also made with reference to what are commonly referred to as “relational databases”, where records are stored in separate tables, relationships are created between the tables, and relations between certain records result. It is to be recognized that relations between records can be made using other techniques, for example, records may be related programmatically through corresponding data in independent records. As a further example, records can be merged together in larger records in less tables or a single table, to create a fixed relationship between the records. Where reference is made to a database it is to be recognized that this does not restrict the physical location of the database to a single file, computer or location. The database may be distributed across many files, computers or locations. For example, the database may utilize data that resides on different computers separated by a communications network, such as the Internet. The database will be stored on a computer-readable medium to pernit computer-implemented access to data in the database.

The database can be used in association with software to allow the input of data into the database, and to permit use of the data from the database for automated purposes. It is recognized that persons skilled in the art will be able to create such software based on the principles described herein and common general knowledge in the art. Such software is included within the scope of the principles described herein. As an example, software can be created to incorporate the methods described herein in computer-implemented methods for use in association with one or more databases as described herein.

Such software will be executed on one or more computers from computer-readable media, such as a read-only memory device (ROM). It is to be recognized that this does not restrict the physical location of the software to a single file, computer or location. The software may be distributed across many files, computers or locations. For example, the software may reside on different computers separated by a communications network, such as the Internet.

The database together with the computer-readable media on which it resides, together with one or more computers used to allow access to data in the database from the computer-readable media result in a system. The software and the computer-readable media on which it resides, together with one or more computers that are used to execute the software, may form part of the system.

Initially, the methods described herein provide a computer-implemented method to configure databases and store therein: an application inventory, sometimes referred to herein as Corporate Application Portfolios, a skill inventory, sometimes referred to as ASM Service Provider capabilities, and services, sometimes referred to as ASM Service Requirements. Further methods can include the use of configured databases in operation to record and manage tickets and timesheets. While still further methods can include the entry of tickets and timesheets to trigger, or the use of configured databases including tickets and timesheets for, benchmarking, stewardship, and governance that is automatically aligned to corporate business strategy. The methods can result in various databases and systems.

The methods and outputs thereof are beneficial for a variety of groups within an organization, including users of the applications, service providers of ASM services, and application owners and key stakeholders. For example, the application owner is the person, group of people, or department that bought, paid for, and uses on a day to day basis the application. They typically also pay the ongoing cost of support and maintenance of the application. The stakeholders would be parties who use and have a vested interest in the application but are not owners.

Inputs required for configuration include an application inventory (those computer software applications for which services are to be provided), a skills inventory (those people that will be providing services), and a list of services (the services that are to be provided for the application inventory). The services will typically be determined based on a corporate strategy of the application owners and key stakeholders, for example, a company during difficult times may reduce services to save money by stating that application enhancements are no longer a valid service; only break-fix is a valid service.

After configuration and during operation, inputs to the methods include tickets and timesheets. Timesheets are time entries for people working on application inventory over a given time period.

Outputs of a system utilizing a configured database can include reports for benchmarking, stewardship and governance.

Further details of the methods and other methods that can be incorporated therein are set out below. It is to be recognized that some of these methods may be useful on their own or as part of other methods.

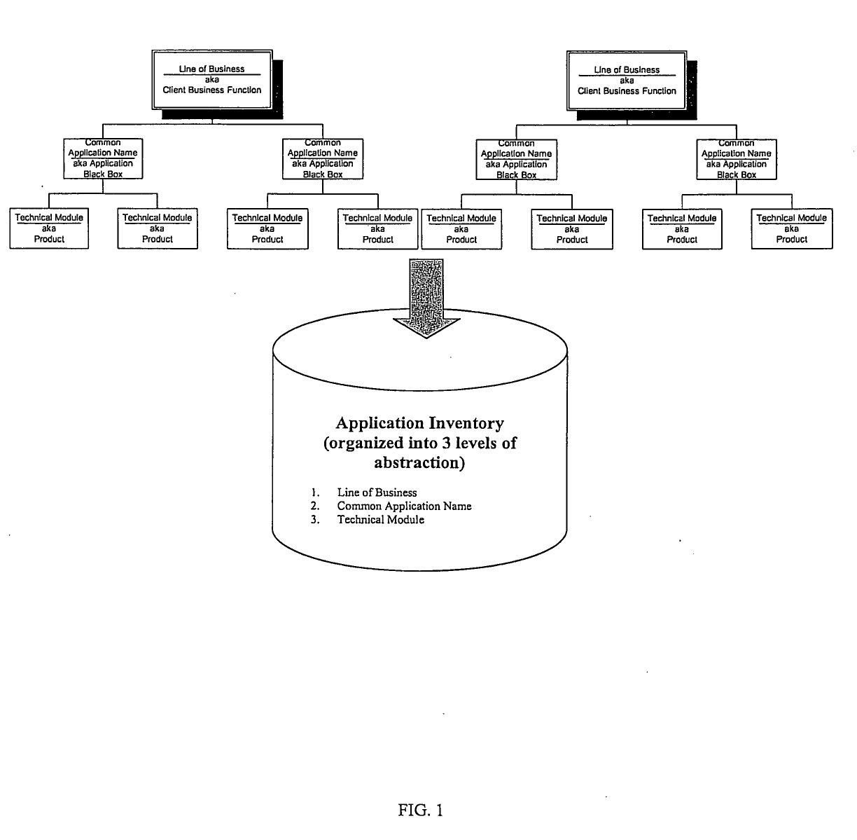

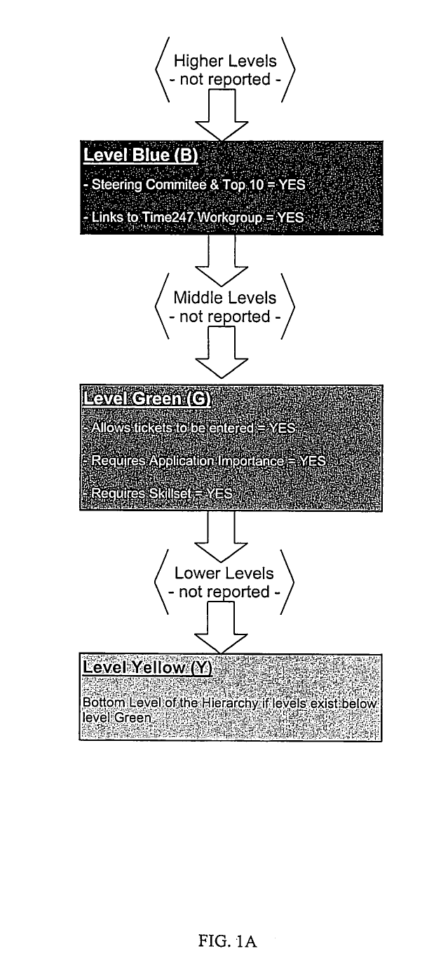

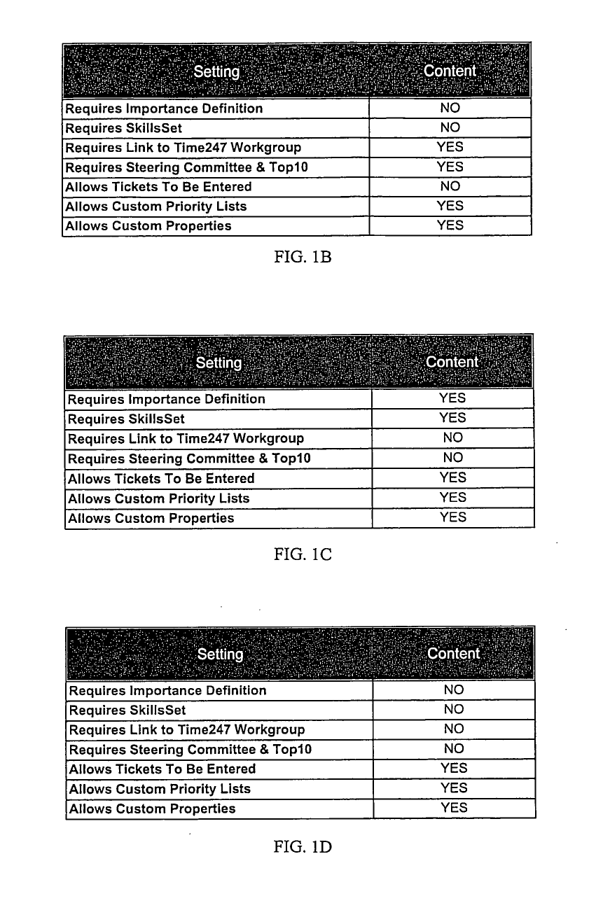

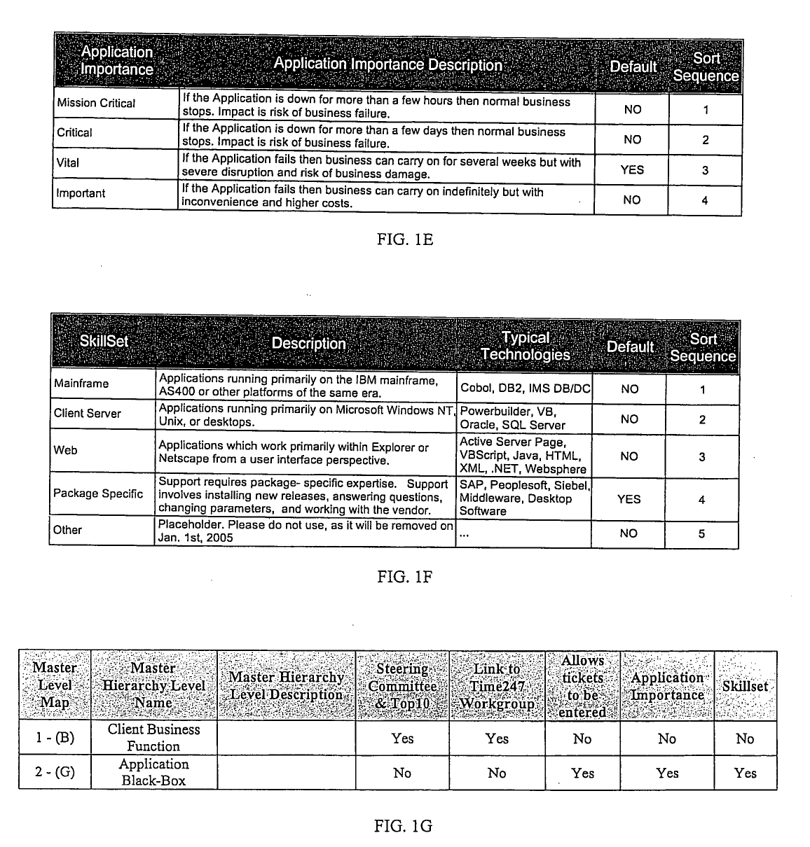

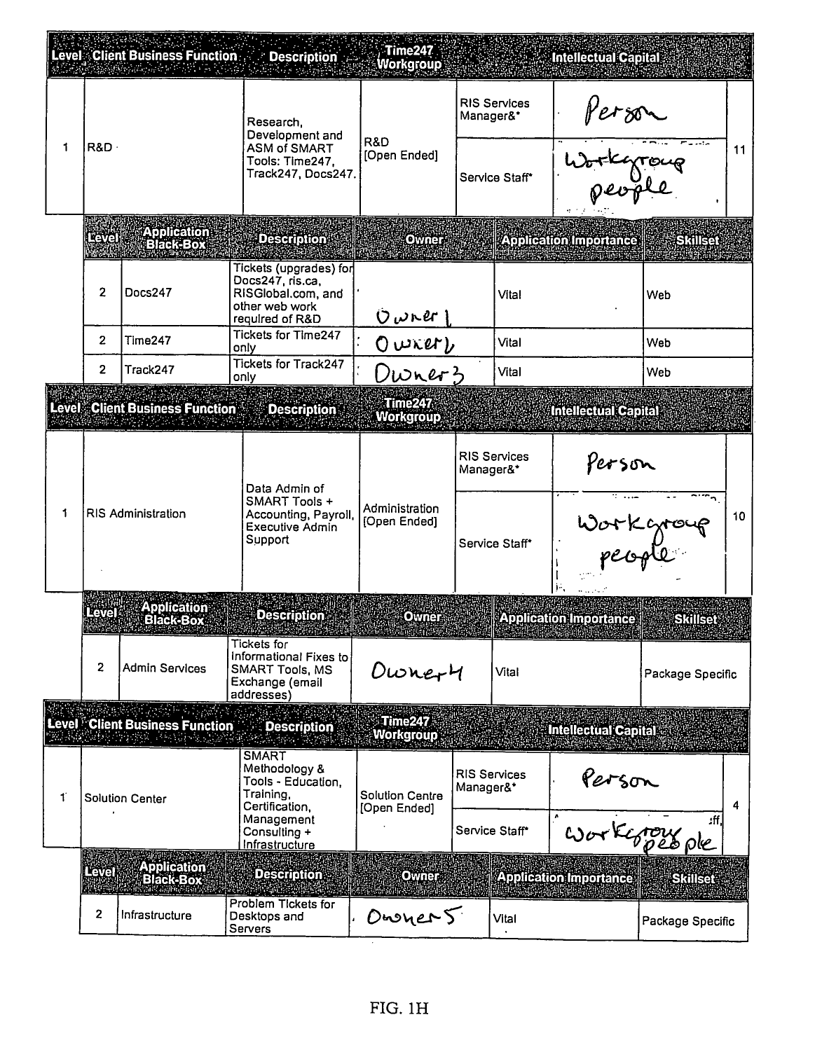

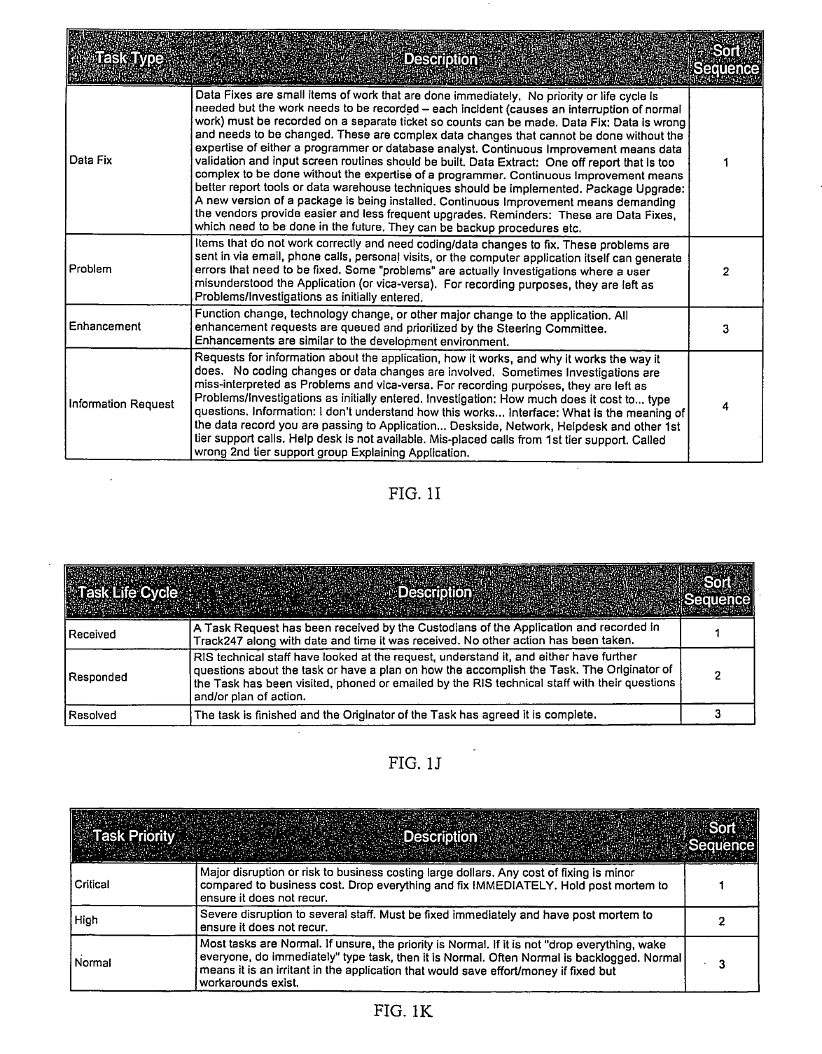

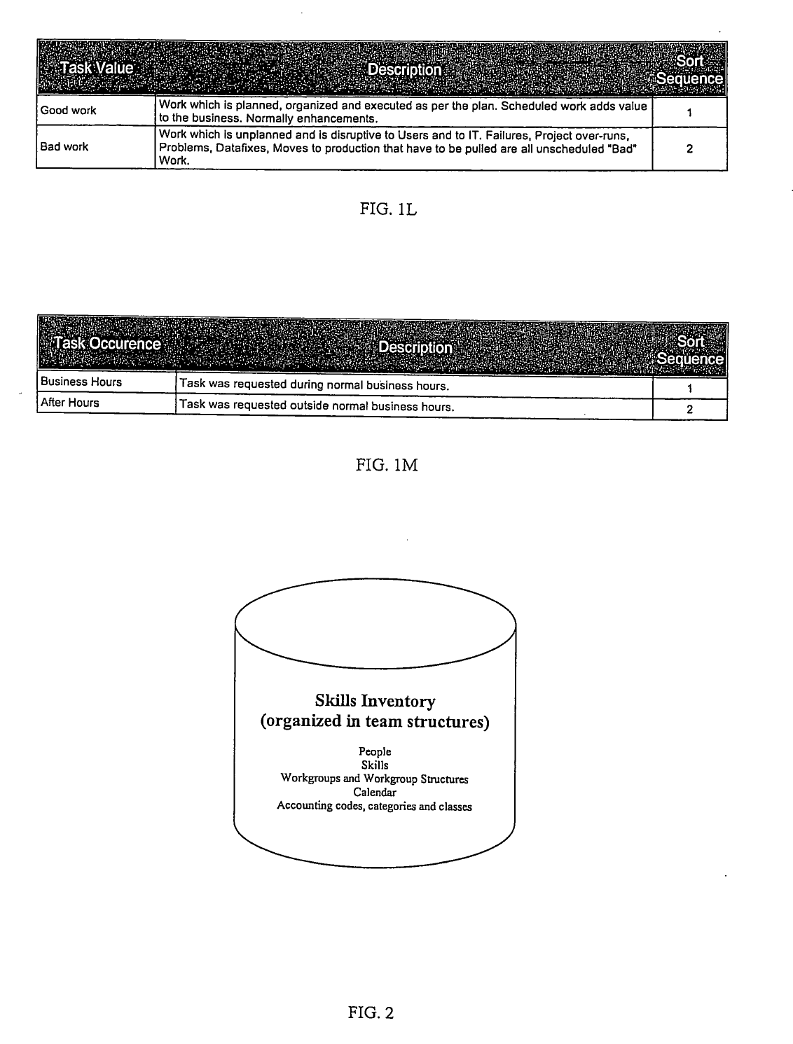

Referring to FIG. 1, a method for classifying application inventory is shown wherein an application portfolio database is first configured.

Inputs for configuration of the application portfolio database are a list of lines of business, a list of application names, and a list of technical modules. A Line of Business is a business function of an organization for whom a computer software application is being supported and maintained. An organization will typically list their lines of business according to logical divisions the business executives of the organization can utilize for strategic planning, costing, governance and stewardship. An application name is the name by which an application is known within an organization by users of the application. The applicant name is used to communicate work requests (tickets) to support and maintenance staff. A technical module is a computer program, software product, or technical module of an application at a level used by support and maintenance staff to support and maintain a computer program application.

The actual names and division of lines of business, application names, and technical modules may vary from organization to organization. This may be a result of, for example, the variance from one organization to the next in business undertaken, internal structure of the organization, strategic priorities, applications employed, and services resources available. Multiple names for the same item can be used within an organization at a given level provided that the names are recognized as equivalents in the application inventory.

The application inventory is stored in a database classified according to a 3-level hierarchy of Line of Business, application name and technical module.

Outputs of configuration of the application portfolio database are a database defining an application portfolio in a 3-level hierarchy that describes the application portfolio at three different levels of abstraction (views): a list of lines of business, a list of application names, and a list of programs known, understood and used in common communication by the ASM Service Provider.

As an example, an application inventory for an oil and gas exploration and production company may be stored in a database as:
Lines of Business—
   1. Exploration
   2. Land
   3. Production Accounting
   4. General Accounting
   5. HR and Payroll

Application Names—

| | | Production | General | HR and |
|---|---|---|---|---|
| Exploration | Land | Accounting | Accounting | Payroll |
| AccuMap | SLIM | Prism | ACCTDB | PeopleSoft |
| XPLOR | ANTTS | Atlas2000 | FLOW | |
| DDF | COAR | | PEEP | |
| | | | PVRWizard | |

Technical Names—

| | |
|---|---|
| Accumap | Accudocs99, Accuin04, Accuput, Accutak |
| XPLOR | Xdb, Xrender, XLBS |
| DDF | DDFv6.3 |
| SLIM | SLIMdb, SLIMfix, SLIMrs |
| ANTTS | ANTTSv3.5 |
| COAR | COAR |
| Prism | Wellview, Wellgen, AssetBook, Whip, BudgetTool |
| Atlas2000 | AtlasV4.4 |
| ACCTDB | ACCT V3.7 |
| FLOW | Wellflow, testflow, |
| PEEP | PEEPCan, PEEPUSA, PEEPSaudi |
| PVRWizard | PVRWizard.net |
| PeopleSoft | ePerformance, ePay, eProfile, eBenefits, Global Payroll |

The application inventory database provides an association between lines of business, application names, and technical modules. By the nature of the definition of lines of business, application names, and technical modules, the database associations are exploited for example as set out herein. For example, by storing tickets in the database under application names then tickets are automatically related to lines of business. Reports can be generated to determine how computer program applications within a given organization are performing by line of business. By storing approvals for work on given tickets in the databases along with timesheets for support and maintenance personnel, it can automatically be seen when support and maintenance work that has not been approved is being performed within a given line of business. Further embodiments of the databases and methods, and uses thereof, will be described herein.

Throughout this description, examples of a notional organization, RIS, will be used. Referring to FIG. 1A, the structure of the configured database is shown. RIS utilizes a 3-level hierarchy wherein the second and third levels are merged for simplicity. In this case, the technical modules and application use the same “Line of Business”, which will be referred to as a “client business function” and the application names and technical modules will be referred to as “Application Black-Box”.

One can see that RIS notionally has three lines of business: R&D, RIS Administration and Solution Centre. These lines of business have application names and technical modules Doc297, Time247, Track247, Admin Services, and Infrastructure. Each application name and technical module is associated with its respective Line of Business.

Work authorization and authorized workgroups are set in the database at the Line of Business level; for example, by following a steering committee decision as will be discussed later herein.

Work requests, typically referred to as “tickets” are set at the Line of Business level or below; preferably at the application name level. An indication of application importance and required skilled set for the application are set at the highest level at which tickets may be set. Tickets can also be entered below the highest level at which tickets can be entered

As an example, within the notional RIS organisation, the application inventory is classified according to the following “Application Taxonomy”.

Application Taxonomy is a Master Classification for all applications supported by RIS. An inventory of applications is discussed later below based on the structure defined here. Application Taxonomy defines how the application assets for which RIS is custodian are to be stored and reported.

The Application Hierarchy defines the multilevel drill-down structure of the applications in an organization. While Tidal (a software program and associated databases within RIS) allows for any of the levels, only three levels are reported as is shown below. When creating an Application Hierarchy at RIS, the following rules are followed.
Rule #1—“Steering Committee & Top 10” and “Link to Time247 Workgroup” definitions are always at the same level. They are permitted at one level only.
Rule #2—“Allow Tickets to be Entered” (at its highest level), “Application Importance” and “Skillset” definitions are always at the same level and they are always at or below Steering Committee level (never higher).
Rule #3—Allow Tickets to be Entered can be at lower levels. The levels are reported as if they are at the level in Rule #2.

There are two types of Application Hierarchy:
Master Application Hierarchy. There is one single Master Application Hierarchy defined for the whole subscriber. It is the default if no Client Specific Application Hierarchy is defined.
It enables subscriber reporting.
Client Specific Taxonomy. This is a client defined Application Hierarchy that applies only to the client. If no Client Specific Hierarchy is defined, the Master Application Hierarchy is used. The Client Specific Hierarchy maps to the Master Application Hierarchy.

The following 3-level hierarchy is the Master Application Hierarchy at RIS:

Client Business Function—

Referring to FIG. 1B, settings for a client business function (Line of Business) are shown. The Client Business Function is an application suite of software products that perform a well-defined, industry-recognised business function for the Client.

Application Black-Box—

Referring to FIG. 1C, settings of an application Black-Box level (application name level) are shown. Application Black-Box is a software application that performs either one business function or one technical function. The Application Black-Box Name will be easily recognised within the client organization. In simplistic situations, the Application Black-Box and the Client Business Function will be the same.

Product—

Referring to FIG. ID, settings for a product level (technical module level) are shown. A Product is an individual software product or program that was either purchased or built in-house. A product (computer program) performs a specific technical function. The product (program) name is recognised by the solution support team (custodians) and some key users (owners).

Application Importance Taxonomy—

Referring to FIG. 1E, a description of the application importance setting is provided. Application Importance enables classification of Applications as per critically to the business. The Application Importance defined here is linked to each application, which in turn, should tie to the Corporate Disaster Recovery Plan for that Application.

Application SkillSet Taxonomy—

Referring to FIG. 1F, a description of the skill set settings is provided. Application SkillSet Taxonomy classifies IT technical skills required for the Support and Maintenance of the Applications.

Referring to FIG. 1G, an example of application hierarchy is shown for the RIS example described above. A configured and populated application inventory database for a portion of the RIS application inventory is shown in FIG. 1H.

Using again the notional RIS example, work requests are referred to as “tasks”. In this example, task taxonomy is embodied in task tracking software and associated databases referred as “Track247” herein. Tasks when entered in Track247 are also referred to by the commonly used term, “tickets”.

Task Taxonomy—

Task Taxonomy is a Master Classification for all activity involved in supporting an application. Reports for the RIS example used herein are based on the Task Taxonomy structure defined here. The Task Taxonomy defines how RIS programmer/analysts input and report their work.

Task Type—

Referring to FIG. 1I, Task Type is a classification of the types of requests with requests with respect to an Application.

Task Life Cycle—

Referring to FIG. 1J, every Task that is requested follows a single, high-level life cycle irrespective of the Task Type. The Task Life Cycle is a sequence of Task Status's that every task must follow according to the following rules:
A Task can be in only one Task Status at a time. It must complete one status before the next status begins. It can only go forward, and it cannot go backward.
The exact sequence (Sort Sequence below) must be followed in the Life Cycle and no steps can be skipped. However, a Task can move immediately from one status to the next so that it appears as if a step was skipped.
Each Status change must have an initiation date and time associated with it so the moment that a Task first entered a status is known. Using the sequence, the length of time the Task stays at one status can easily be calculated. The length of time a Task stays at a status can be zero. Task Life Cycle is a universal hard-coded Best Practice in Track247. It cannot be changed.
   Task Priority—

Referring to FIG. 1K, Task Priority is the importance of a task that has been requested. It is used where there is a large number of tasks that need further breakdown.

Task Value—

Referring to FIG. 1L, Task Value identifies the Business value of each task being done. It identifies a task as to whether it is Good Work—adding value to the business by potentially increasing revenue or decreasing costs—or Bad Work—repairing errors, fixing disruptive mistakes that cause increasing costs andlor risk of decreased revenue. Good Work is normally Enhancements that have been prioritized in a Top 10 and approved by the Steering Committee. Bad Work is normally Problems that disrupt normal workflow.

Task Occurrence—

Referring to FIG. 1M, task occurrence identifies when the request came in.

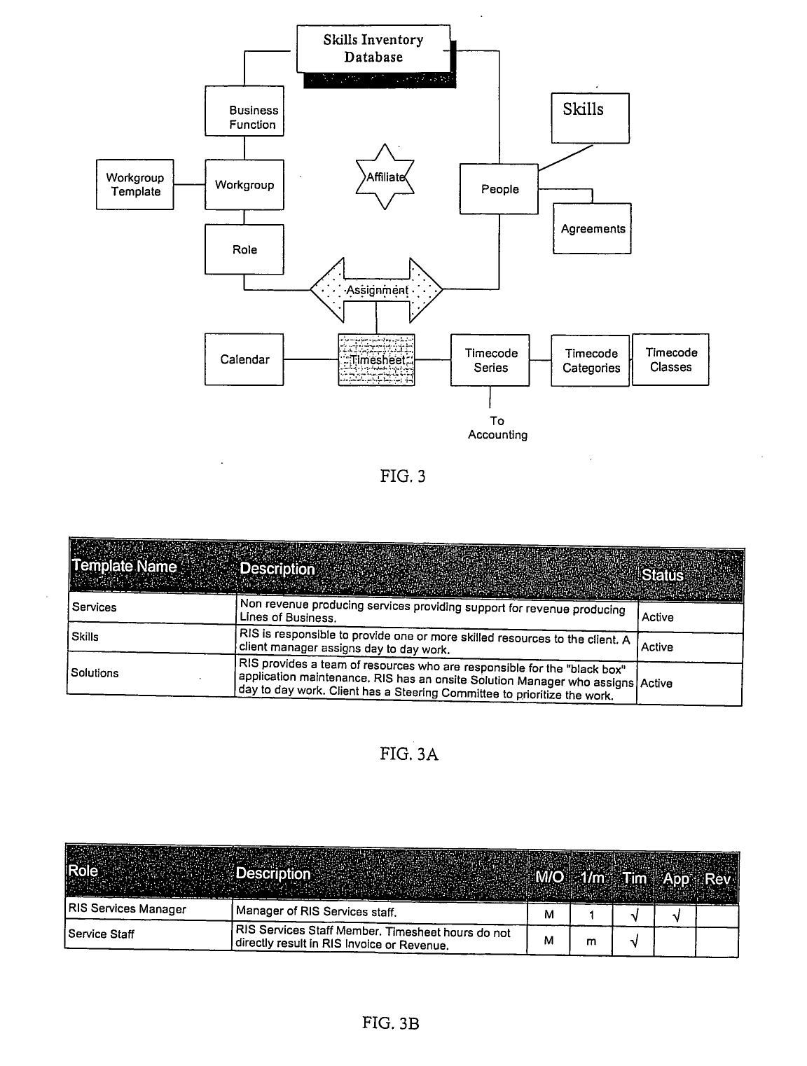

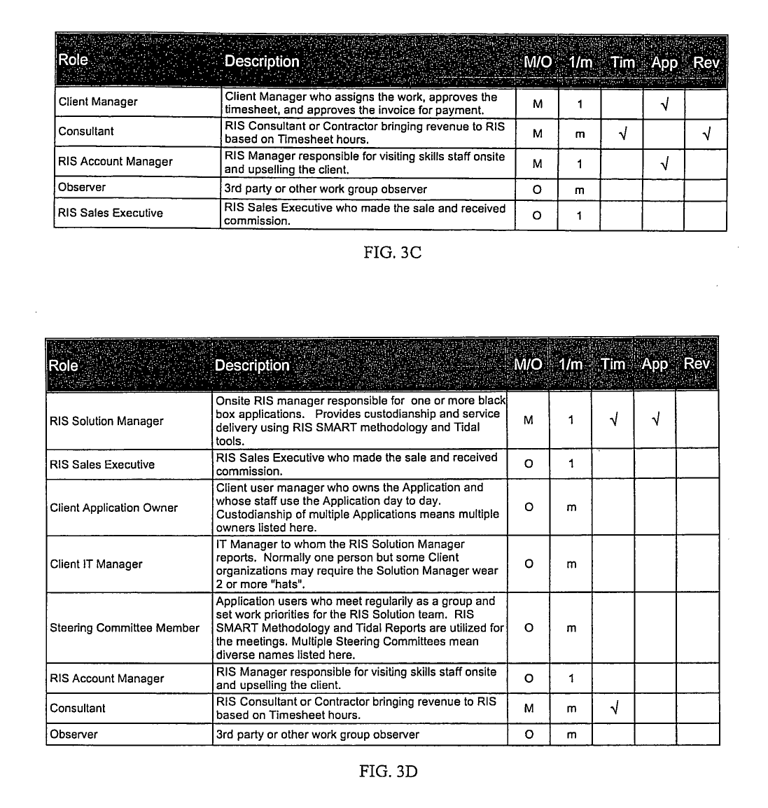

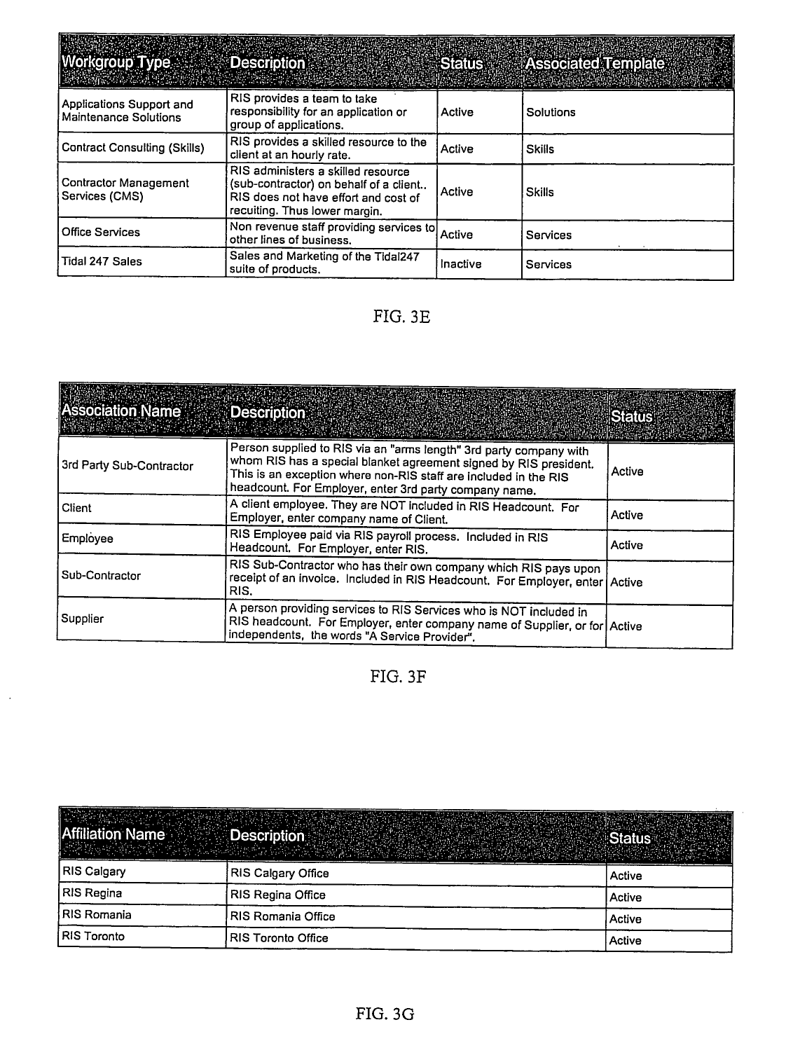

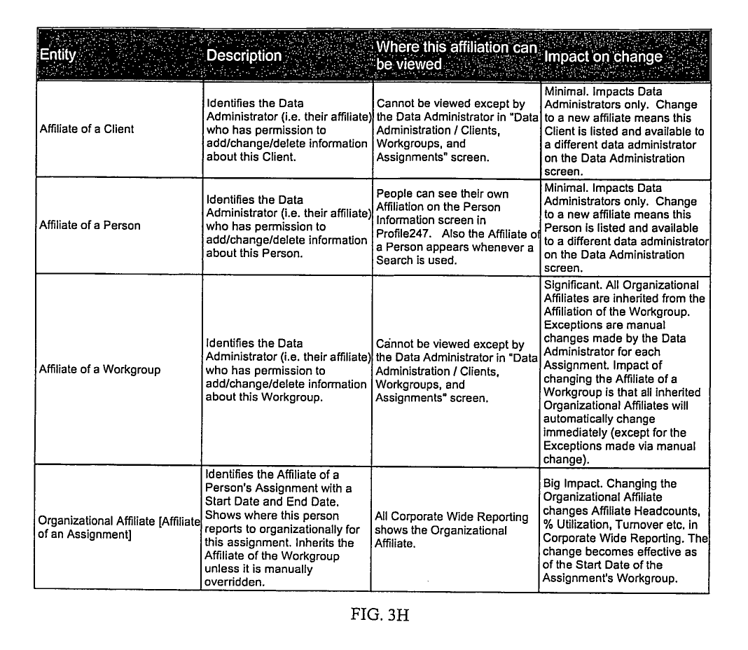

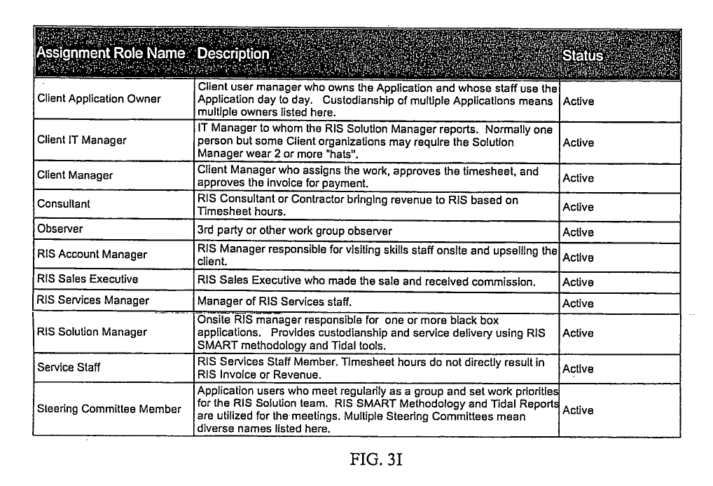

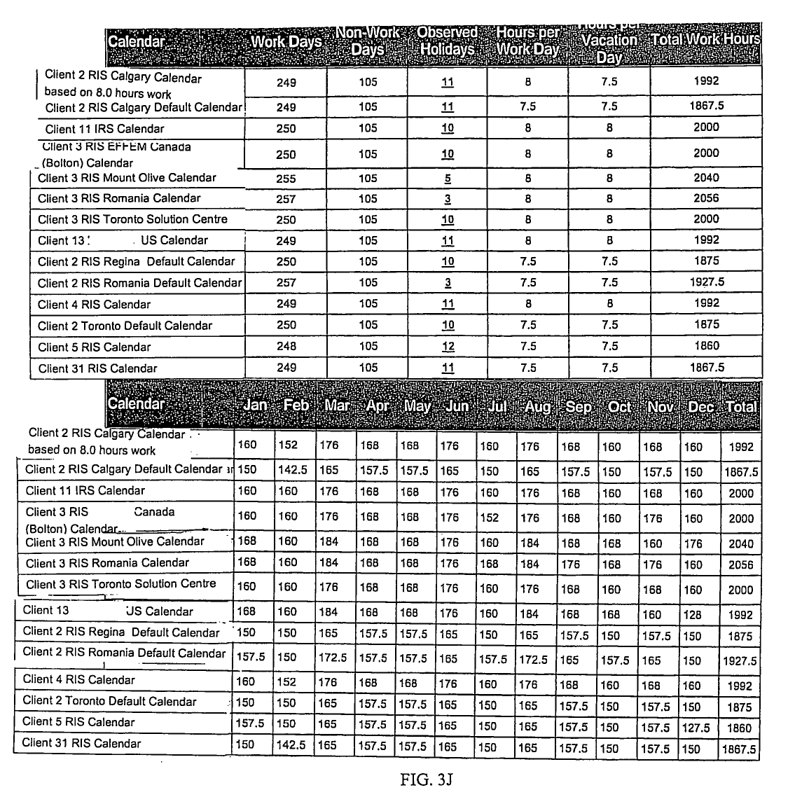

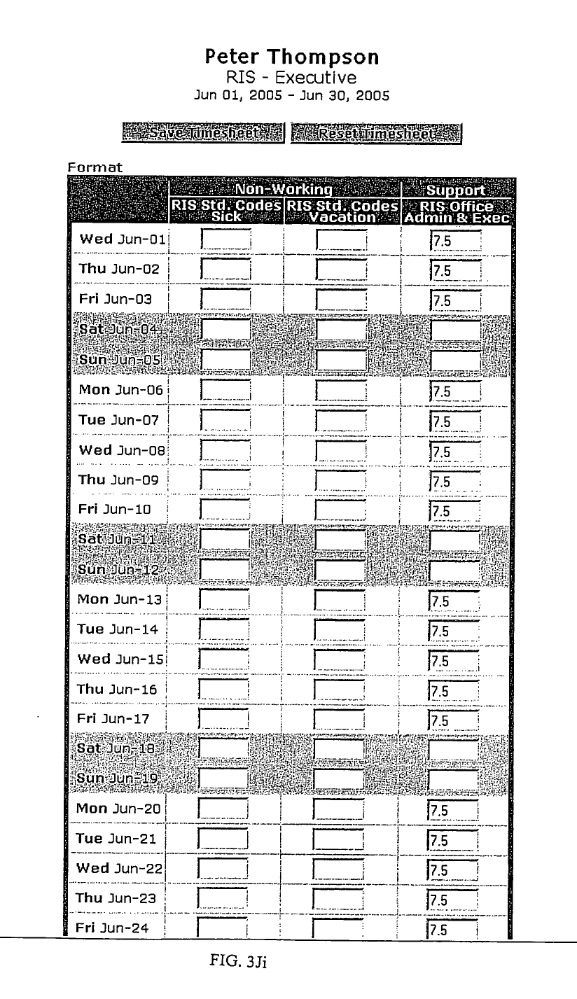

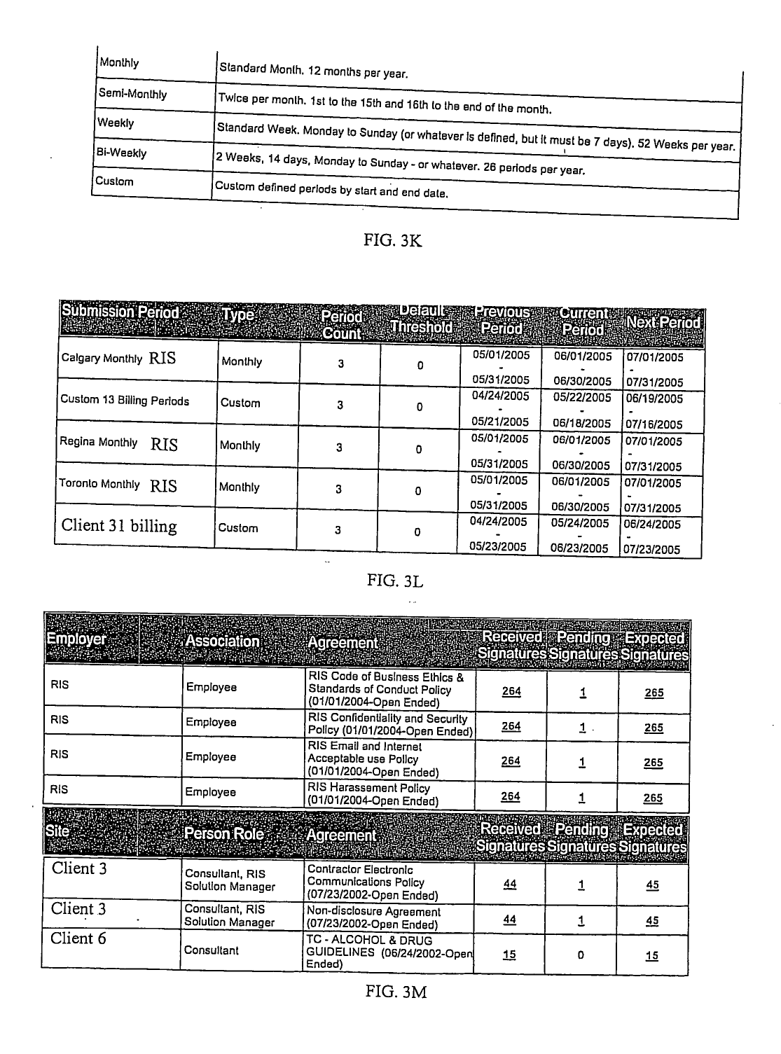

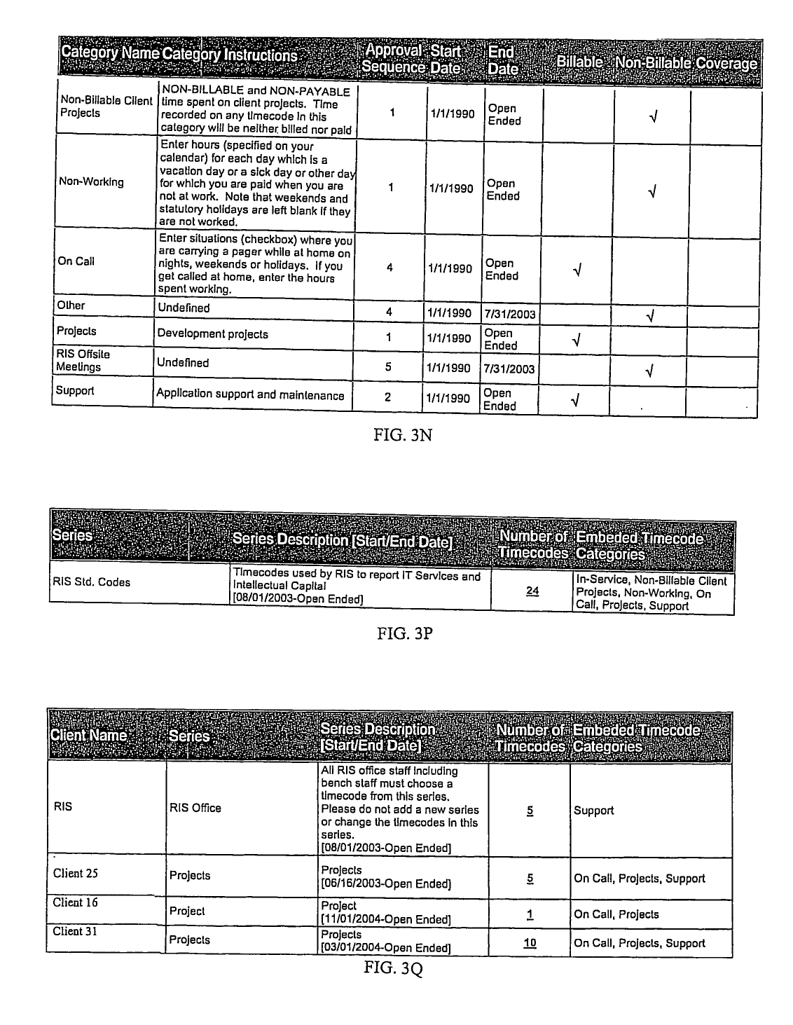

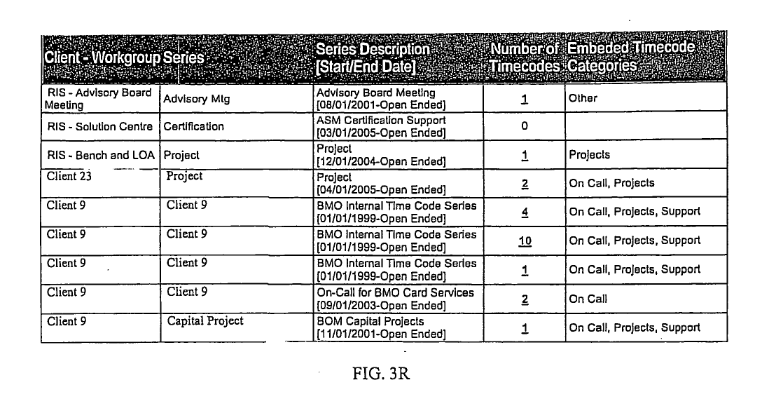

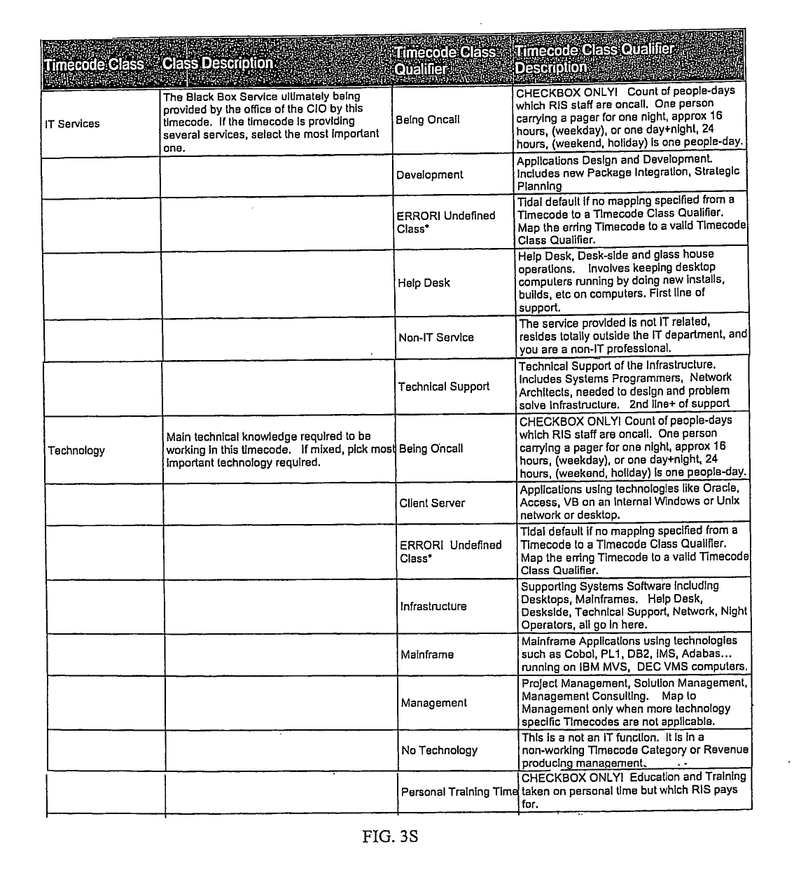

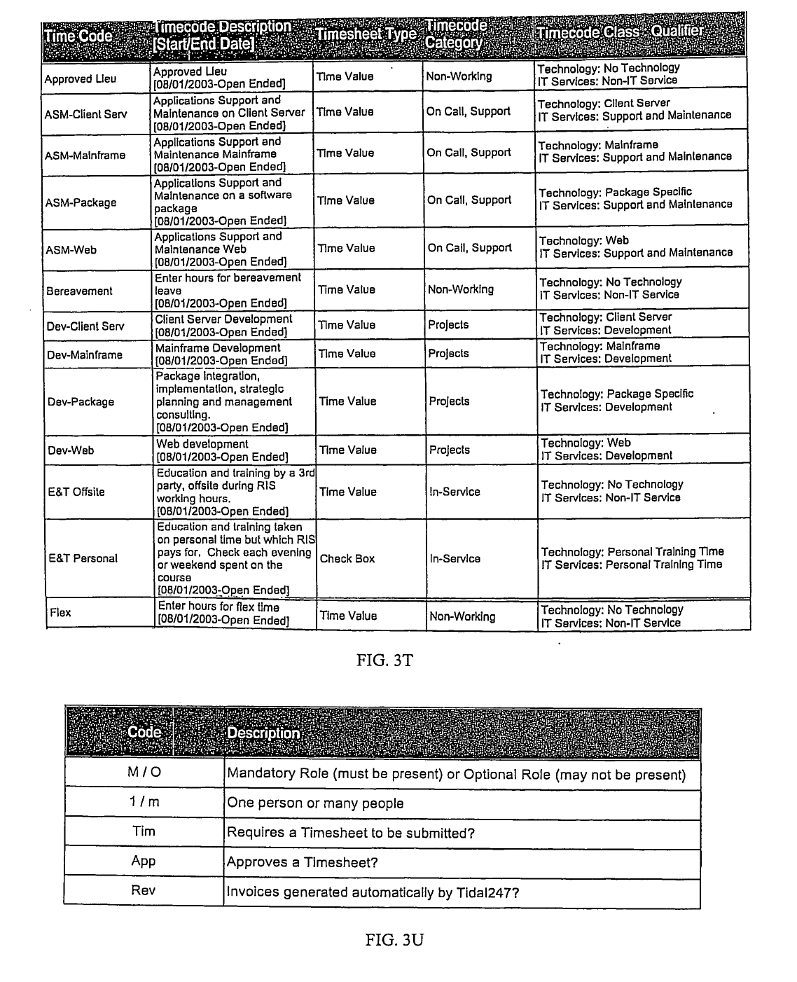

Referring to FIGS. 2 and 3, a method for creating workgroups (teams of technical programmers) with needed skills for maintaining an application inventory is shown. The method provides a skill inventory database.

Inputs of the method include intellectual capital, availability, expertise required for services, and cost and management reporting requirements. Intellectual capital is made up of people and their skills, capabilities and experience. Availability is the availability of the intellectual capital based on a calendar (reflecting working days for the intellectual capital) and current workgroup assignments. Intellectual capital that is otherwise assigned may not have sufficient available time for assignment to another workgroup.

The workgroups are stored in a workgroup database. The workgroups reflect available computer skills capable of working on the application inventory. The workgroups are tied to the lines of business as each workgroup includes assignment to individual application names and technical modules that are tied to lines of business through the application inventory database.

Output of this method is a workgroup database defining workgroups of people into several teams (workgroups) capable of providing services on applications. Each workgroup may include people from a variety of disciplines, professions, departments, companies and geographic locations.

Referring to FIG. 3A, an example configuration using the methods and databases identified with respect to FIGS. 2 and 3 is shown, for example, applied to the notional organization RIS. Some of the details of the methods and databases will be further described in this example. The skills inventory database in RIS is accessed through software programs known as “Tidal247” and “Time247”. In this example, the organization, RIS, will be referred to as the subscriber.

The skills inventory database is configured for a particular organization using a series of configuration tables such as those described in the example.

The internal business structure of the subscriber is defined using Tidal247 through a series of templates. This example lists the subscriber's Lines of Business and then describes the staff team structure for each Line of Business. All staff in the subscriber's organization fit into one of these team structures. Thus, when a person is hired, Tidal247 knows where each person can be assigned, what role they play, how they will be counted in headcount, and where and how the hours are reported.

Headcount in this example means that a person is currently assigned to work on at least one assignment, and the person has the “timesheet required” box checked for this assignment. If a person is currently working on two assignments with “timesheet required”, only one is counted in the headcount. The assignment with the earliest start date (or the earliest timestamp if the start dates are the same) is counted and the other is ignored.

Business Model Templates defined in RIS—

The Business Model Templates define fundamental team structures on which all Lines of Business of the corporation are built. An example list of templates is shown in FIG. 3A. Each of the Business Model Templates listed in FIG. 3A has the respective detailed team structure outlined in FIGS. 3B-3D.

A description for the example codes used in FIGS. 3B-3D is provided in FIG. 3H. Every Workgroup Template should have at least one Role that has “Approves a Timesheet” code set. Otherwise, no one associated with the workgroup will be able to approve timesheets for this Workgroup. Every Workgroup Template should have at least one Role that has “Requires a Timesheet to be submitted” code set. Otherwise, no timesheets will be created, and headcount reports, which are based on the “Requires a Timesheet” code, will show all zeros for this Workgroup.

Lines of Business—

Referring to FIG. 3E mentioned previously, the Lines of Business may be the profit centers and/or cost centers in the Corporation. The staff team structure for each Line of Business is associated with one of the Business Model Template structures described above in this example. All staff are assigned to a team in one of the Lines of Business. Lines of Business are called Workgroup Types in Tidal247. In this example, five Lines of Business are shown, although one is inactive.

Staff Associations Permitted—

Referring to FIG. 3F, Staff Associations define the relationship of a person to RIS. Associations are used to show the makeup of the workforce at RIS. Associations are totally independent of Business Models, Lines of Business or the role of the person on the assignment. The Associations are used by Tidal247 to distinguish how staff are paid, either directly via Tidal247 or indirectly via interfaces to payroll and other applications. For example, subcontractors can be paid directly, employees via interface to a payroll system, and third party suppliers via totally separate processes outside Tidal247.

Affiliates—

Referring to FIG. 3G, Affiliates is an administrative breakdown of all data in Tidal247. It enables different administrators in large corporations to work fairly independently in updating and reporting data. However, the data itself still applies to the whole database irrespective of who updates it. Affiliates often define branch offices.

Referring to FIG. 3H, affiliation is attached in Tidal247 to the entities shown, each of which is described later in this example.

It is possible to provide exceptions where the Organisational Affiliate can be manually overridden, if desired to account for particular circumstances.

Roles—

Referring to FIG. 3I, a list of staff positions in any Line of Business at RIS is shown. Note that theses roles are already described in the Business Model Templates above, but are shown here for completeness.

Calendars—

Referring to FIG. 3J, a Calendar defines the days of the week that are expected to be worked (Work Days) and the number of hours expected to be worked each of those days. The days of the week that are not worked (Non-Work Days) are defined as having zero expected hours. The Calendar also defines the observed (statutory) holidays in the year that are normally Work Days, but which by government or other regulation, are not worked.

The Calendar defines required content for the Timesheet. An example RIS Timesheet input screen is shown in FIG. 3Ji. Non-Work Days and Statutory Holidays have a shaded background and Work Days have a white background. The Calendar also defines the Expected Number of Work Hours for each month, or other time period as a calculate value: total hours in each Work Day of the timesheet period, minus the total number of hours associated with Observed Holidays. If the number of reported hours is exceeding the Expected Hours with more than a Submission Period defined Threshold, a message will appear at the bottom of the timesheet Summary. Example Calendars are as follows—

Every Timesheet completed in Time247 by this subscriber must link to at least one of the Calendars. In this example, time related functions are implemented through a computer program referred to as “Time247”. The Calendar(s) that a person sees in their timesheet is based on their assignment to a Workgroup, which inherits the information from the associated Client.

Every Client must be linked to at least one Calendar before any workgroups and assignments can be created for that Client. When linking a Calendar to a Client, an Affiliation must also be specified (normally the Affiliate of the Client). Thus, a Client must have one Affiliate of the Client (see Affiliates) and should have one or more “calendar+affiliate” (See “Client Calendars and Submission Periods” for a list).

A Workgroup must have a Calendar. It can inherit its calendar from the Client using its own Affiliate of the Workgroup to decide which Client Calendar to inherit. It can also have its own Calendar (no Affiliate specified), which overrides any inheritance procedure.

A Person on an Assignment (the Calendar seen on the timesheet) inherits their Calendars from the Workgroup. Persons can have their own personal Calendar for an assignment that overrides all other Calendars that could be inherited for that assignment.

The Calendars defined for each Client, Workgroup, and Assignment is shown in Line of Business Details in this example.

Submission Periods—

Referring to FIG. 3K, Submission Periods define the frequency of timesheet submission for approval. For Timesheets, it defines how many consecutive days appear on the timesheet. For example, if the Submission Period is monthly, all the days in the month will appear and the Submission Period will define which seven days will appear and in what order.

Referring to FIG. 3L, defined Submission Periods for RIS are shown. Future Period Count defines how many timesheets into the future a person can see on their screen and enter hours.

Default Threshold defines how many hours over the Calendar Expected Work Hours can be entered without being warned with the following message:

“You recorded <B> billable and <N> non-billable hours on your timesheet. This reflects an excess of <X=B+N−E> hours over the expected hours of <E> for this timesheet. As per Company policy, excess hours are not accrued. If you require additional information, please contact your Manager.”

Every Timesheet completed in Time247 for this subscriber must link to one of the Submission Periods as outlined in FIG. 3L. The Submission Period that a person sees in their timesheet is based on their assignment to a Workgroup, which inherits the information from the associated Client.

Every Client is linked to as least one Submission Period before any assignments can be created for that Client. When linking a Submission Period to a Client, an Affiliation must also be specified (normally the Affiliate of the Client). Thus, a Client must have one Affiliate of the Client (see Affiliates) and should have one or more “Submission Period+affiliate” (See “Client Calendars and Submission Periods” for a list).

A Workgroup has a Submission Period. It can inherit its Submission Period from the Client using its own Affiliate of the Workgroup to decide which Client Submission Period to inherit. It can also have its own Submission Period (no Affiliate specified) that overrides and inheritance procedure.

A person on an Assignment (the Submission Period seen on the timesheet) inherits their Submission Period form the Workgroup. Persons can have their own personal Submission Period for an assignment that overrides all other Submission Periods that could be inherited for that assignment.

The Submission Periods defined for each Client, Workgroup, and Assignment is shown in Lines of Business Details in this example.

Agreements—

Referring to FIG. 3M, persons logging onto Tidal247 may be required to sign agreements. For example, Employer Agreements—where all persons of a certain association who log onto Tidal247 are required to sign an agreement, and Site Agreements where persons in specific roles at specified client sites must sign the agreement.

Timecode Category—

Referring to FIG. 3N, Timecode Category is the first (top) line in every Timesheet. It groups the Timecodes on the Timesheet. There is a single set of Timecode Categories for the entire Subscriber Database. The Timecode Categories define the overall Timecode structure for all time gathering for the Subscriber.

The set of Timecode Categories for subscriber RIS are shown in FIG. 3N.

Timecode Series—

Referring to FIG. 3P-3R, Timecode Series is a set of Timecodes that a person selects from when they are “Formatting their Timesheet”. There can be several Timecode Series (set of Timecodes) within a subscriber from which a person can choose.

Persons who are completing on Tidal247 select a Timecode to put their time against from the set of Timecodes listed in the Timecode Series. Each Client and/or each Workgroup may have several Timecode Series. A person may have to look through the timecodes of several Series in the Format Timesheet Screen to find the correct Timecode. The Format Timesheet Screen lists all Series and Timecodes available to a person.

The Timecode Series (one or more) that a person has access to for filling in their timesheet depends on their Assignment(s). Another way of looking at Timecode Series is a way of grouping timecodes so persons filling in a timesheet looks at subset (e.g., a Client's) of timecodes rather than every timecode in Tidal247.

A Timecode Series can be specific to a Client (available only to staff on assignment with that Client) or Workgroup (available only to staff on assignment with that Workgroup) or to the Subscriber (available to everyone). A person filling in a Timesheet sees only the Timecode Series of their Workgroup, or only the Series of their Client if their Workgroup has no Series attached, or only the Subscriber Default Series if no Series are attached to their Client or Workgroup. Timecodes used anytime previously continue to be available unless they are inactivated via the End Date of the Series or the End Date of the Timecode.

One single Timecode cannot be in two Series. Each Series defines a unique Timecode. If the same Timecode name is used, everything is still treated as separate although reporting will be confusing. Every Subscriber has one Subscriber Default Timecode Series that is used in situations where a Timecode Series has not been specified for a Client or Workgroup.

An example Subscriber (Default) series association for RIS is shown in FIG. 3P.

An example Client Series association for RIS is shown in FIG. 3Q. The series are available only to the persons with assignments at the client specified. Only Billable Timecode Categories are permitted within the Timecodes.

An example Workgroup Series association is shown in FIG. 3R. The series are available only to the persons with assignments at the client and on the Workgroup specified. Only Billable Timecode Categories are permitted within the Timecodes.

Timecode Classes—

Referring to FIG. 3S, example Timecode Classes are shown. Timecode Classes enable rollup of timecode hours into standardized subscriber-wide Timecode Class Qualifiers. Up to five Timecode Classes can be specified for a Subscriber. When a Timecode Class is specified, every Timecode maps to one of the Class Qualifiers within the Class.

Timecodes—

Referring to FIG. 3T, example Timecodes are shown. Timecodes within Categories define the columns of the Timesheet and represent the finest level of detail on which hours and checkboxes can be recorded within a day. One single Timecode can be in two (or more) Categories but will sum to a single number when reported as a Timecode.

Thus, Timecode+Category is the finest level of detail for reporting hours, Timecode is the next level or reporting, followed by Series, Classification, Category. FIG. 3T lists all Timecodes in Subscriber Series Timecodes. To display Client and Workgroup Timecodes, click “Number of Timecodes” within the Series table.

Timecode: a 15-character name that appears on the timesheet header and bottom line.

Timecode Description: Describes to the end-user what should and should not be recorded in this Timecode. It appears on the timesheet as a mouse-over on the Timecode.

[Start Date, End Date] Valid Dates Between Which a Timecode can be Used.

Timesheet Type is one of Time Value (enter hours only), Time Value With Description (enter hours and a brief description explaining these hours), and Checkbox (check means yes—event occurred, non-check means no—event did not occur).

Timecode Categories ties this Timecode to one or more Timecode Categories. Note that the individual Timecode, not the Series, is tied to a Category.

Timecode Class/Qualifier: lists all the Timecode Class Qualifiers that this timecode maps to.

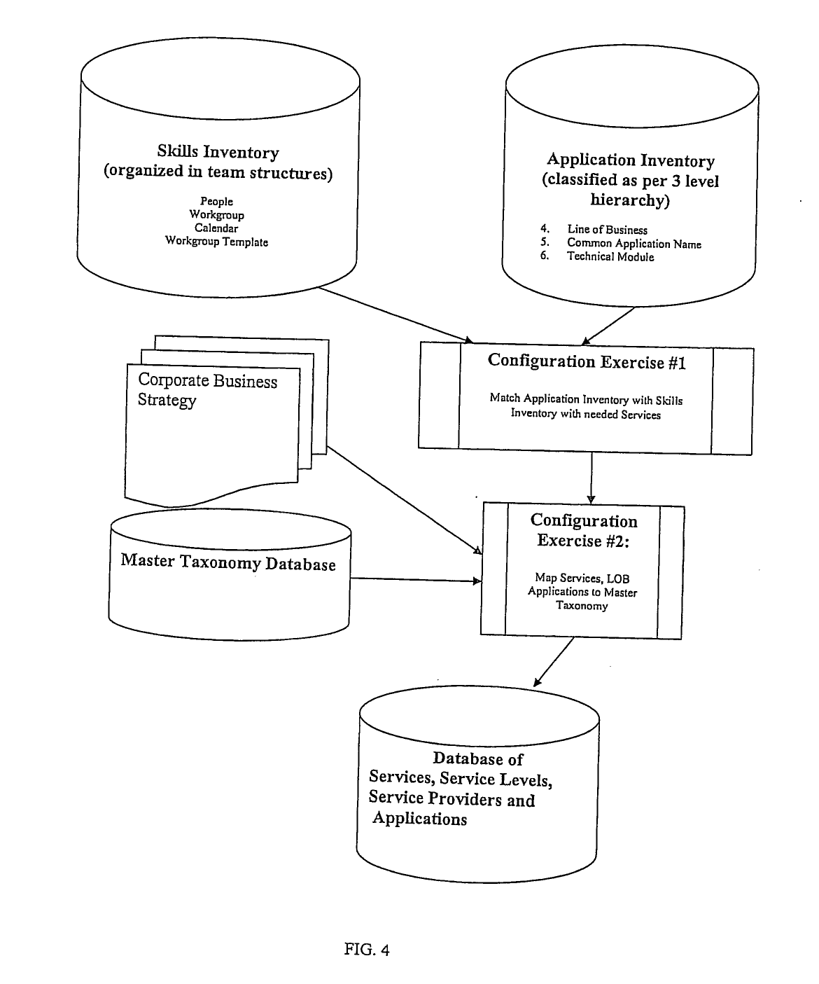

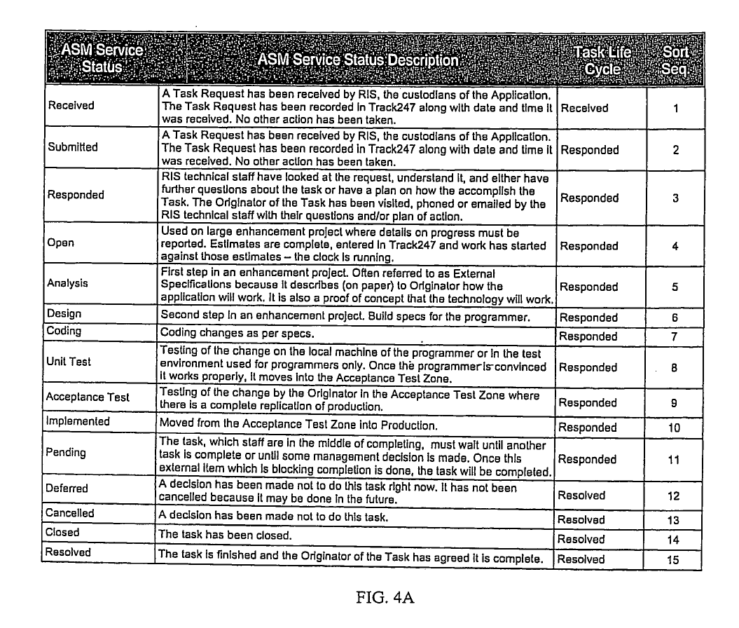

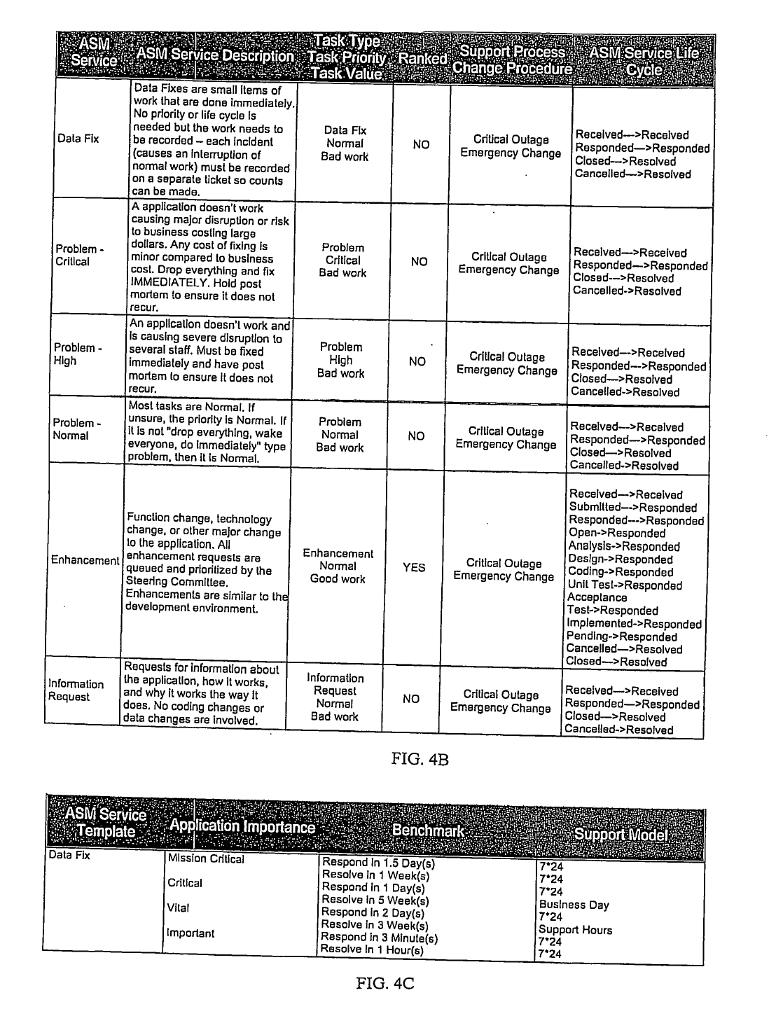

Referring to FIG. 4, a method of classifying services to be performed on application inventory by the skilled workgroups is shown.

The method involves the storing in a database a list of services that will be performed by a workgroup on the application inventory of a Line of Business.

A service level and benchmark (target time to responded resolved each service) are associated with each service.

ASM Templates—

Using again the RIS example, Subscriber RIS is an ASM Service Provider providing ASM Services. ASM Service Templates define which ASM Services will be provided (and by omission which ASM Services will not be provided).

Each client site designs their own specific ASM Service Template where the ASM Services are defined using words familiar to the client environment. When entering a Ticket, the ASM Service Template forces the site programmer to select from the site ASM Service Template. The ASM Service Template then maps the Service to the Task Taxonomy (which is transparent to the programmer) and tells the programmer which procedures to follow for this ASM Service.

An ASM Service Template maps the Ticket Input (essential fields on a Ticket Create Screen) to the five sections in the Task Taxonomy. The Ticket's essential fields and how they interact with the ASM Service Template are described below:
Ticket ID: Unique id for each task request
Ticket Title: Short description of task to be done (up to 70 characters)
Ticket Description: Long description of task to be done (unlimited characters)
Application: An Application selected from the Application Hierarchy defined for this client.
ASM Service: One of the selected services from the ASM Service Template defined for this client.

Each ASM Service maps to a Task Type, Task Priority and Task Value.
ASM Service Status: Definition of where this Ticket is in its life cycle as defined in the ASM.

Service Template—ASM Service Life Cycle. Each ASM Service has a defined life cycle that maps to the Task Life Cycle, following the rules of the Task Life Cycle.
Ticket Occurrence: Same as Task Occurrence above.
Originator: Person or organization that requested the task and is the task champion.

Note that the mapping from ASM Service to the Task Taxonomy need not be one-to-one. For example, several separate ASM Services may be defined that map to the same Task Taxonomy entry. Also, there may be Task Taxonomy entries that are not mapped.

ASM Service Status—

Referring to FIG. 4A, ASM Service Status is the set of all possible status that can be selected from when designing the life cycle for an ASM Service. It is a superset of the Task Life Cycle status: Received, Responded, Resolved.

ASM Service Template—Default

Referring to FIG. 4B, if there is no client specific ASM Service Template, the following default is used. The ASM Service Life Cycle is the Life Cycle of the ASM Service with a mapping from each ASM Service Status to the corresponding Task Status. Task Life Cycle rules are followed by the ASM Service Life Cycle. - - - > means the timestamp of the Task Life Cycle event (Received, Responded, Resolved) is set as of time-now. -> means the timestamp of the Task Life Cycle event (Received, Responded, Resolved) is set as of time-now only if it is a new Task Life Cycle event.

ASM Service Benchmark—Default

Referring to FIG. 4C, an ASM Service Benchmark sets the expected level of service for responding to and resolving ASM Service Requests based on the type of Service being requested and the importance of the application. The default ASM Service Benchmark is an extension of the ASM Service Template. It is used as default if a client specific ASM Service Benchmark is not found.

Respond/Resolve in & hours means the support model is 7×24 (7 days per week, 24 hours per day) where personnel are expected to be available night and day to respond to and work on requests. The Benchmark time to Respond/Resolve begins immediately the minute the Ticket is Received. There is no calendar.

Respond/Resolve in & workhours means the support model is Support Hours where personnel are expected to be available during normal working hours to respond to and work on requests. The Benchmark time to Respond/Resolve begins when the Ticket is received if it is received during work hours or the beginning of the next workday if it is received during non-working hours. A Time247 Calendar must be specified to identify the workdays and work hours. The Benchmark time does not measure time when personnel are not expected to be at work. For example, for an 8am to 5pm Monday to Friday calendar, a Ticket received at 3pm Friday and responded to at 10am Monday has a response time of four hours (whereas in 7×24 it has a response time of 67 hours).

Respond/Resolve in & workdays means the support model is Business Days where, as in workhours, personnel are expected to be available during normal working hours to respond to and work on requests but the measurement of time is in days, not hours. The Benchmark time to Respond/Resolve begins on the day when the Ticket is received irrespective of the time of day it is received, and counts the days until it is Responded/Resolved. A Ticket that is received and Responded/Resolved on the same day has zero days. A Time247 Calendar must be specified to identify the workdays. The Benchmark time does not measure days when personnel are not expected to be at work. For example, for an 8am to 5pm Monday to Friday calendar, a Ticket received at 3pm Friday and responded to at 10am Monday has a response time of one day.

Not Applicable means no Benchmark is specified.

Once the above methods have configured the various databases, further methods can use the databases in operation.

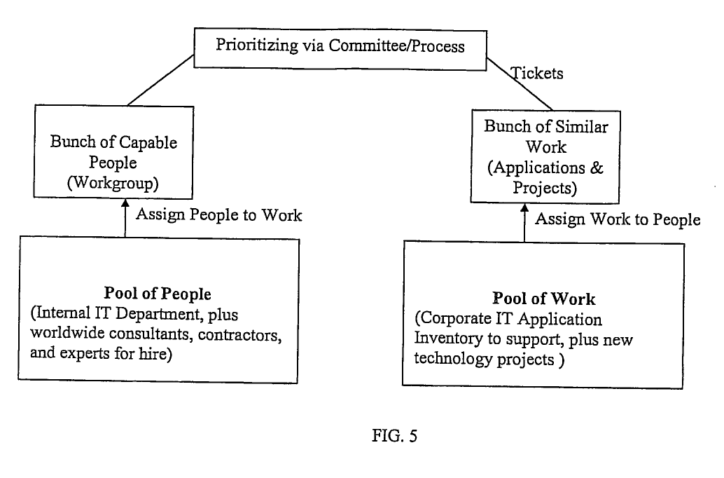

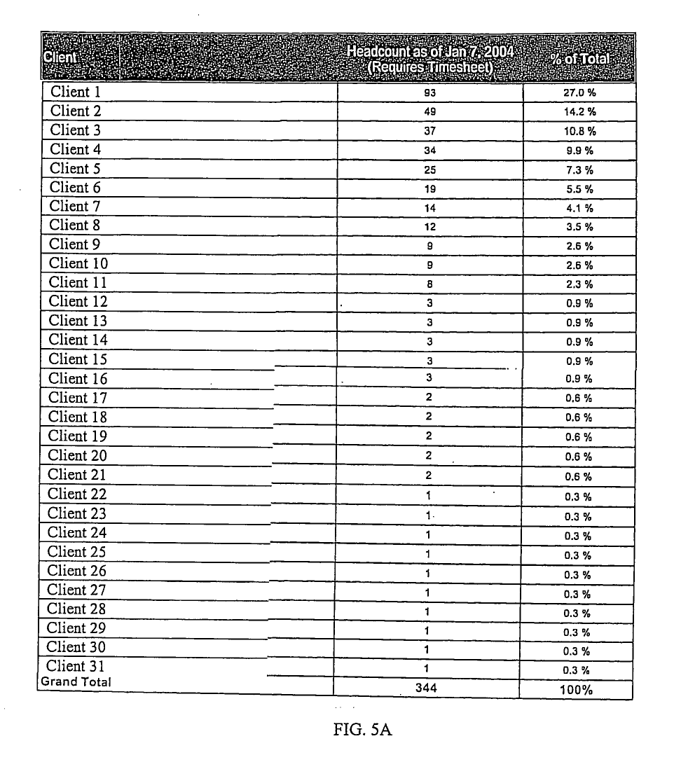

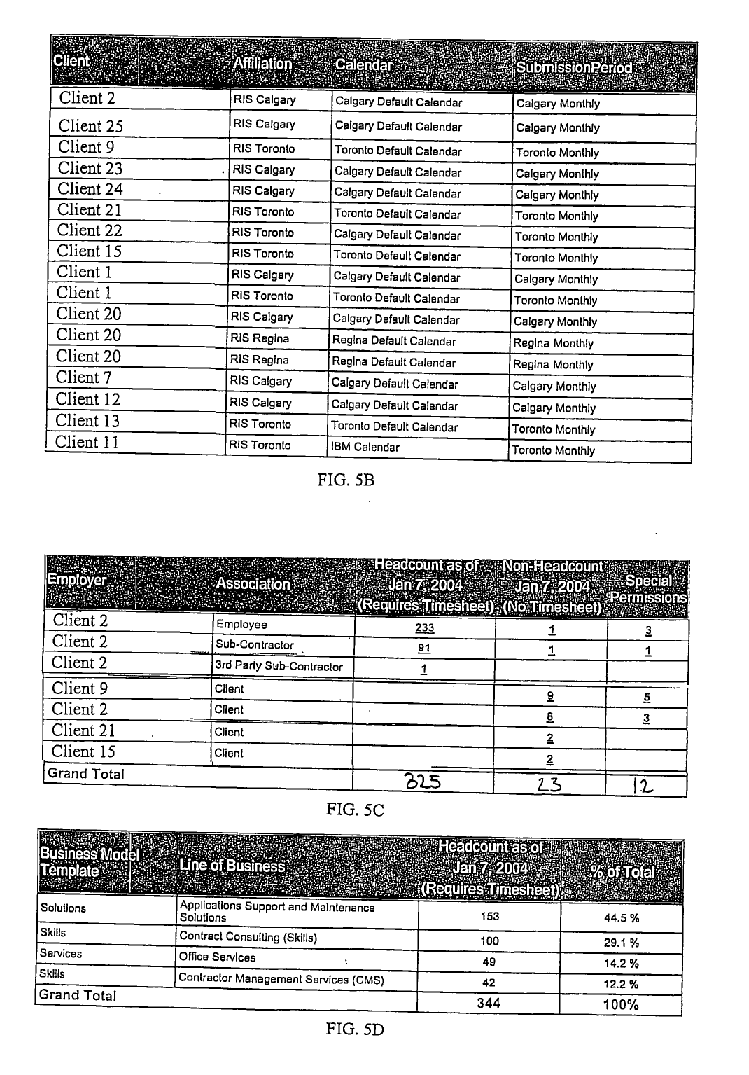

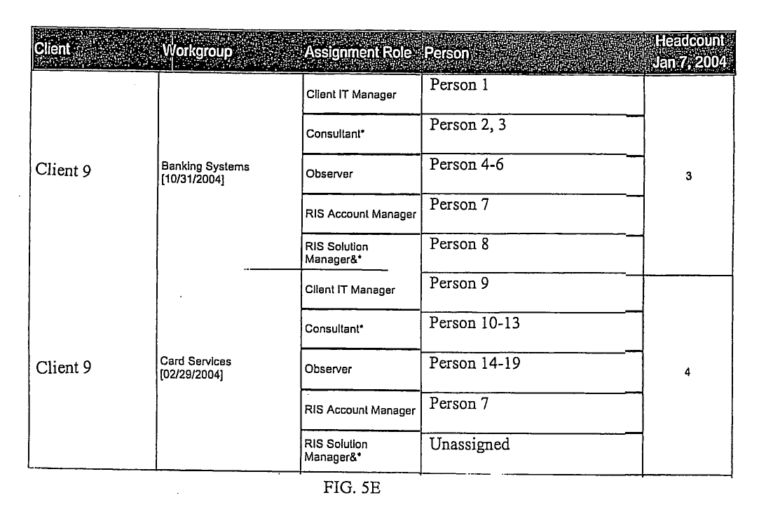

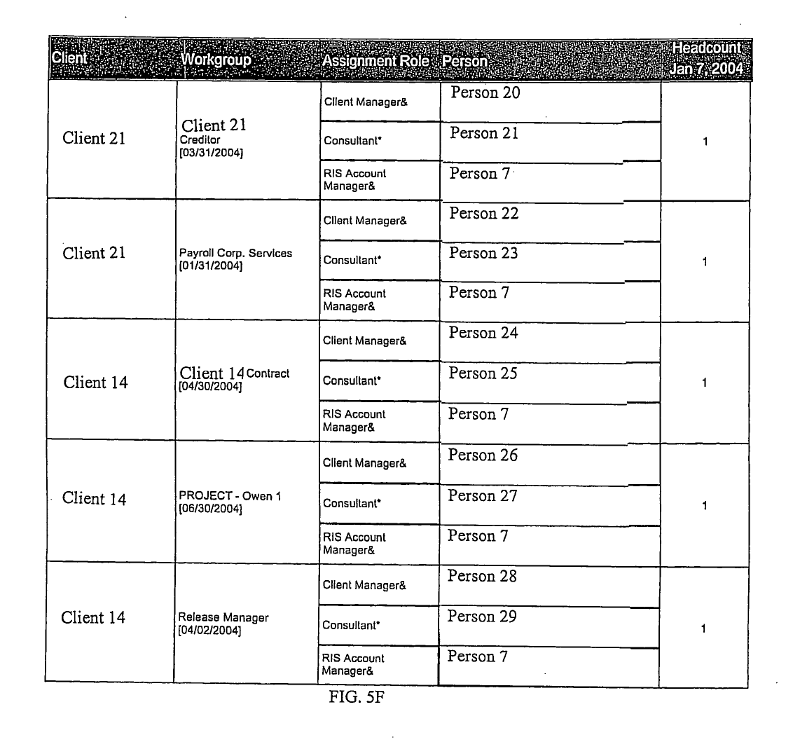

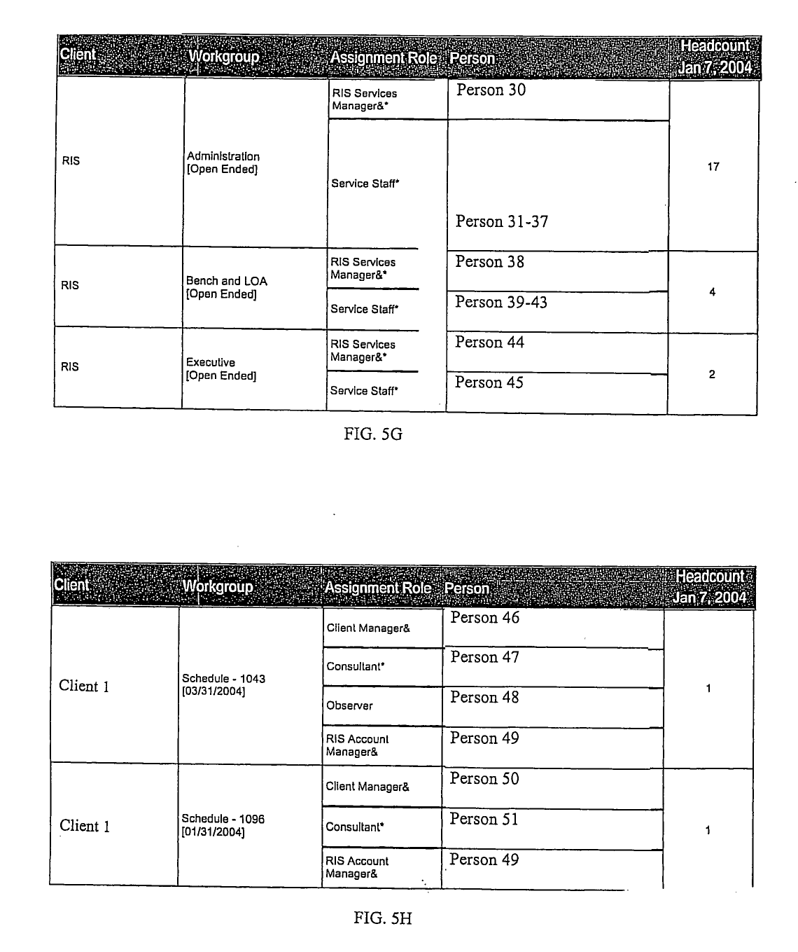

Referring to FIG. 5, a method of creating a two-way work assignment is shown. People are dynamically assigned to work via multiple workgroup assignments. In practice, each person will have a primary work assignment for use in headcount calculations. People are assigned to workgroups with a start date and an end date, with an expectation of providing timesheets for workdays between these dates. Workgroups are assigned to applications in the application inventory.

To some degree, examples of workgroups have been discussed above with respects to Application Inventory. Referring to FIG. 5A and above, further example workgroup associations particularly as they relate to headcount calculations, will be described with respect to our notional RIS example. In this example, the headcount results will be shown first and then the manner in which the headcount is determined from database associations will also be described.

Client—

For RIS, Clients are the entities that pay the bills for the work recorded in the Timesheets. Clients can be either a third party company or they can be internal departments within the company. In Tidal247, the only information needed about a Client is a name and the Affiliation from where the Client is being administered and managed.

In this example, Headcount against a Client means that person is currently assigned to work for this client, the person has the “timesheet required” box checked for this assignment, and if a person is working at two clients simultaneously, only one is counted. The assignment with the earliest start date (or the earliest timestamp if the start dates are the same) is counted and the other is ignored.

Client Calendars and Submission Periods—

For RIS, currently defined Client Calendars and Submission Periods are as follows (sorted alphabetically).

Employer—

For RIS, Employer is the company that pays the person for services rendered by that person. The Employer, unlike Client, is not a separate list but rather is an attribute of every person entered into Tidal247. The Employer is selected from the list of companies defined under Client.

Lines of Business Headcount—

Based on the skills associations, within Tidal247 when doing Site Administration, the internal Tidal247 technical term for “Line of Business” is “Workgroup Type”, and the internal Tidal247 technical term for “Business Model Template” is “Workgroup Template”.

Lines of Business Headcount Details—

Referring to FIG. 5E-5H, within each Line of Business is a set of Workgroups. A Workgroup is a team of people supporting a Line of Business. One Line of Business can have several teams (Workgroups) supporting it.

The Workgroup defines teams of experts who deliver a service for a Line of Business. Workgroups are purely a delivery structure for managing headcount. They do not define organizational hierarchy and are not related to billing, invoicing, or costing.

A naming convention for workgroups should be followed. If the workgroup is a large number of people with a single manager, the manager of the Workgroup should be permitted to select a meaningful name to which all members of the team in the workgroup can relate. If the Workgroups are numerous and small then the Workgroup name should follow a standard recognized throughout the Subscriber organization. Examples of such standards are: Purchase Order #, contract id, schedule id, client name+person last name. The standard will be obvious from the list below. For workgroups where the team uses Track247 to track Tickets, the Workgroup Name must be associated with, and preferably match exactly, the associated Client Business Function in Track247.
Business Model Template: Solutions
Line of Business: Applications Support and Maintenance Solutions

Referring to FIG. 5E, for this Line of Business, RIS provides a team to take responsibility for an application or group of applications. The assignment of a person to a workgroup in a role is shown. Those roles that been designated as “Requires a Timesheet” are shown with an asterisk and counted in headcount.
Business Model Template: Skills
Line of Business: Contract Consulting (Skills)

Referring to FIG. 5F, for this Line of Business, RIS provides a skilled resource to the client at an hourly rate.
Business Model Template: Services
Line of Business: Office Services

Referring to FIG. 5G, for this Line of Business, RIS has non-revenue staff providing services to other Lines of Business.
Business Model Template: Skills
Line of Business: Contractor Management Services (CMS)

Referring to FIG. 5H, for this Line of Business, RIS administers a skilled resource (sub-contractor) on behalf of a client.

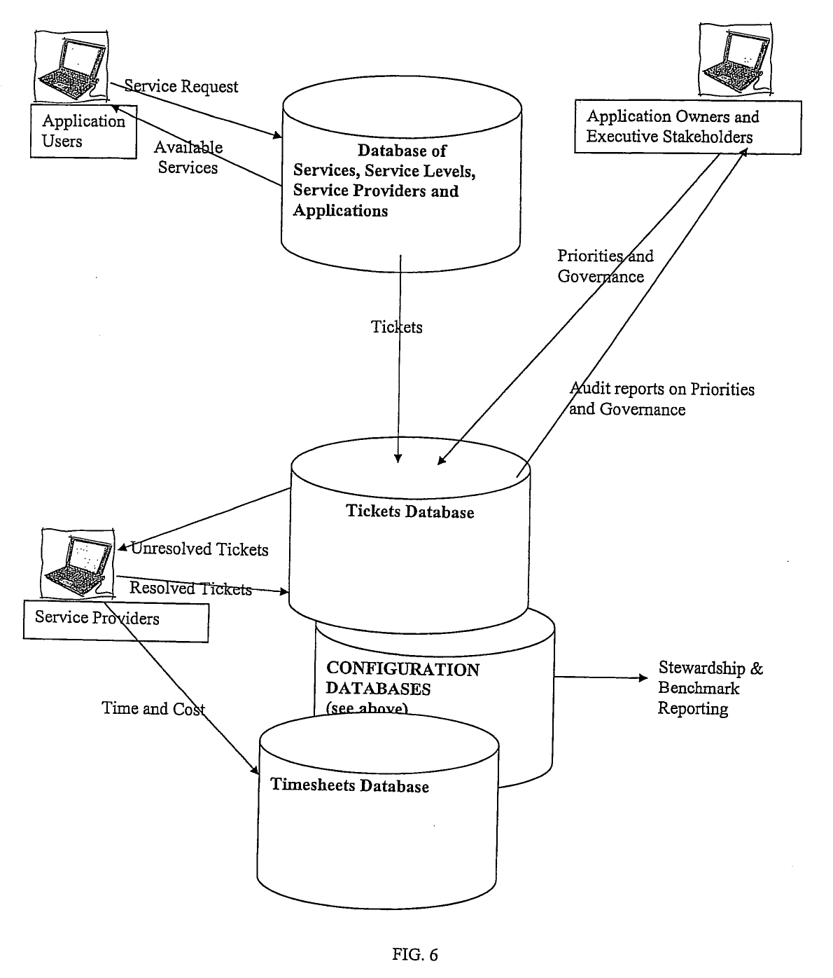

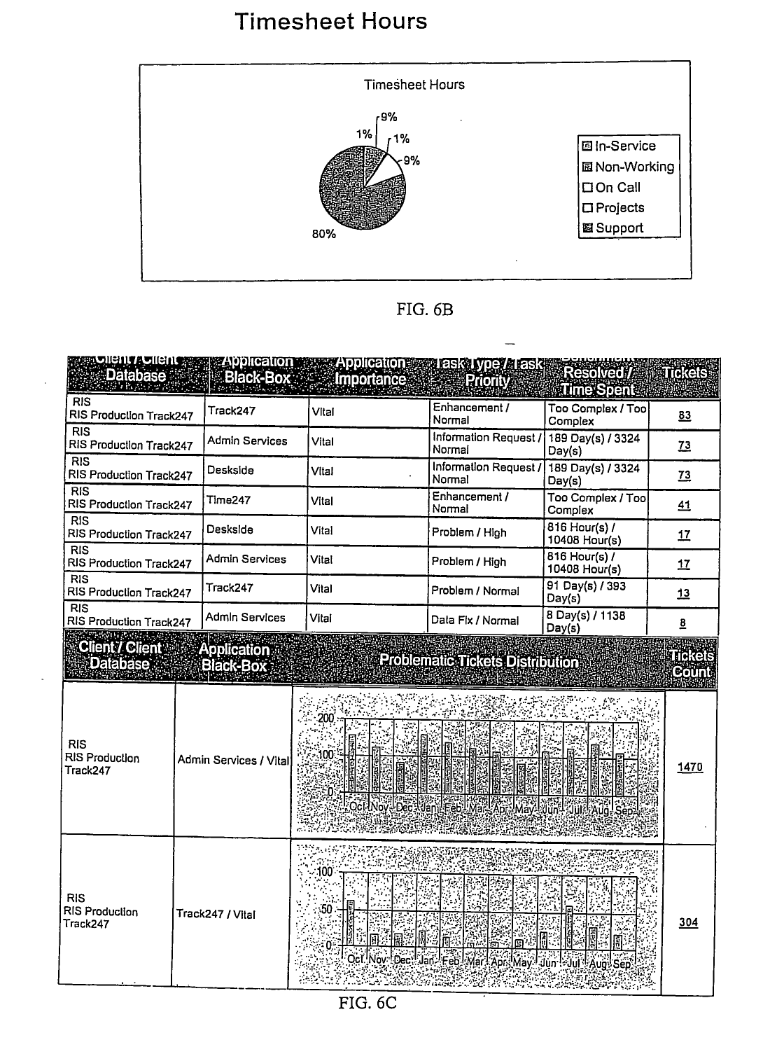

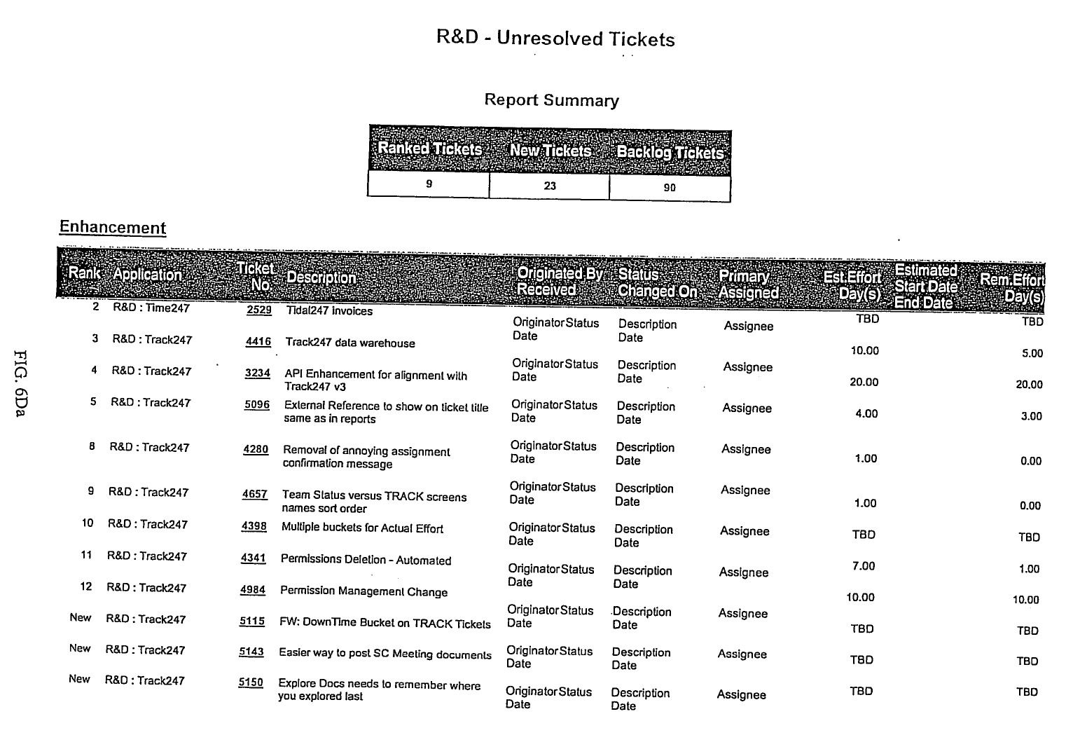

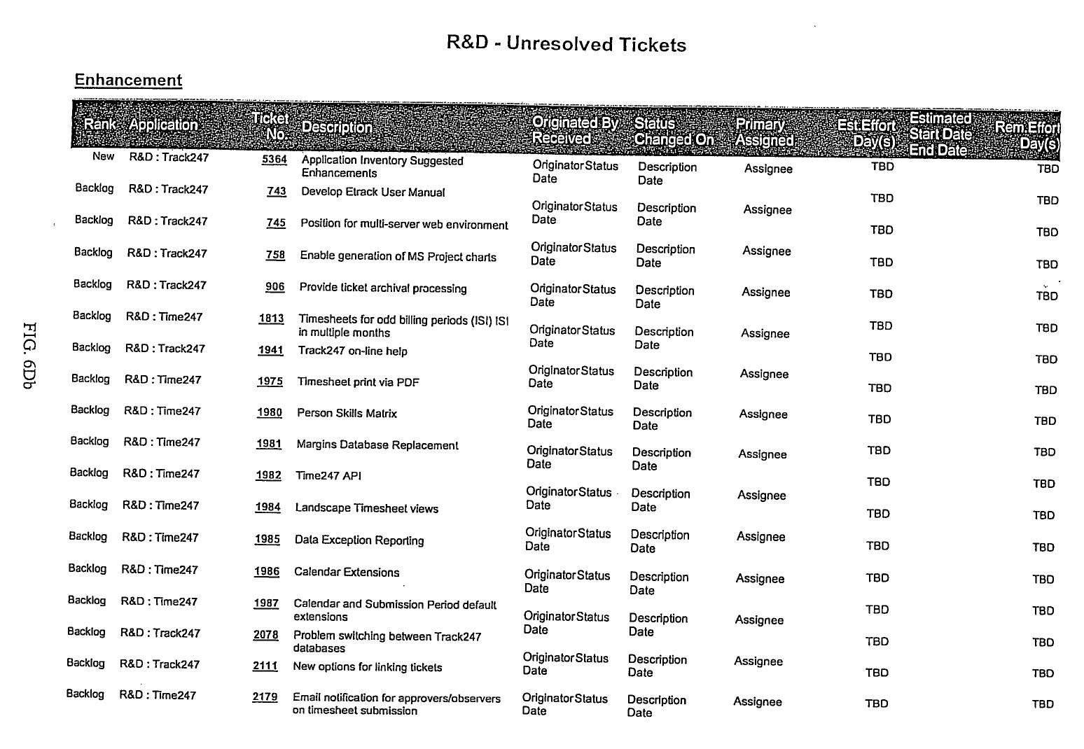

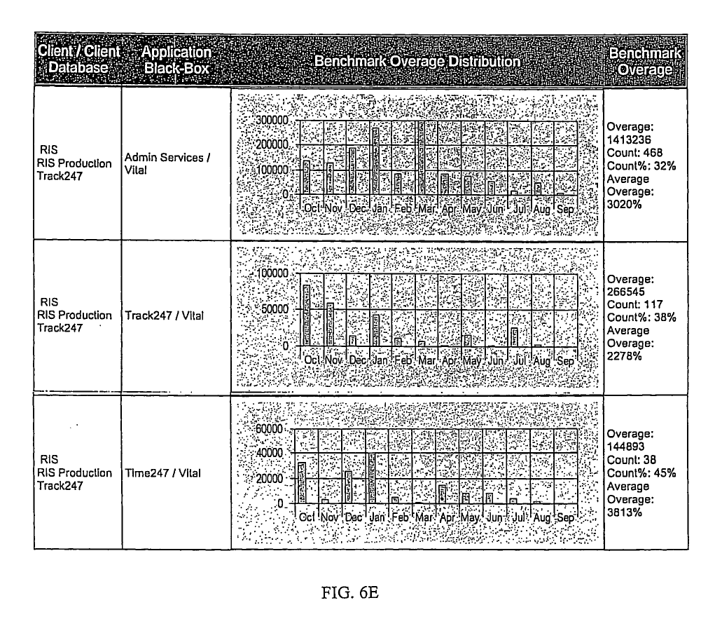

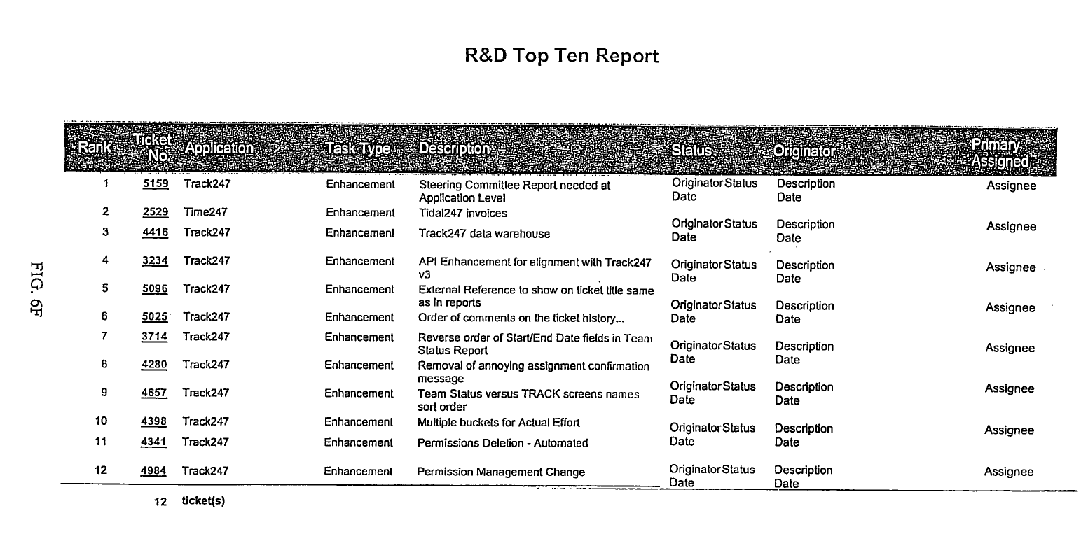

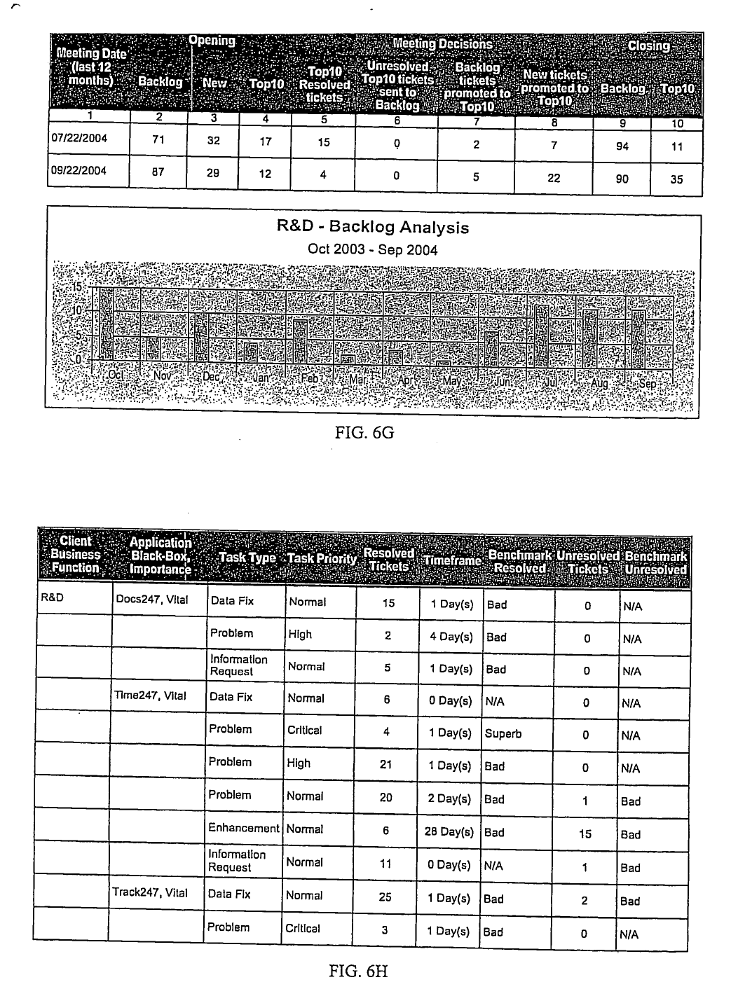

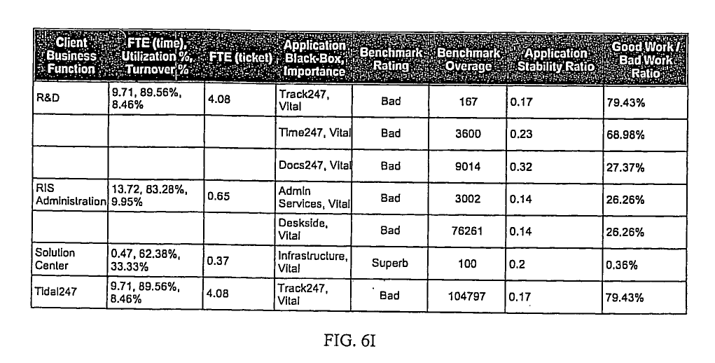

Referring to FIG. 6, the methods can further implement corporate governance by validating that only tickets above a given priority (authorized work) are worked on. Work is dynamically assigned to people via tickets. Tickets are assigned to people. Tickets are capable of recording actual and estimated time to complete the work of the ticket.

A priority is entered for each ticket (and thus the work represented by the ticket). The priority is determined independently of the database and related software, preferably via a committee/process. Governance can be implemented by refusing to accept timesheet entries on tickets that are not above the given priority. The refusal can be implemented through software or the database. By refusing to enter time on unauthorized work, people are greatly discouraged from performing such work. Similarly, people are encouraged to perform authorized work.

The methods can implement stewardship by reporting intellectual capital (people and their capability), application inventory (information technology assets), and activity by people working to improve the application inventory.

Timesheet Hours—

Referring to FIG. 6B, a timesheet hours report is shown in the form of a spreadsheet pivot table. This report includes, as an example, all hours recorded in timesheets during a selected 12-month interval. Timesheet hours are provided from the Time247 database. In the pivot table, one can double-click on any sum of hours to get a list of records making up the number. A pie chart is included in this spreadsheet to illustrate the distribution of timesheet hours for the selected criteria. The default criteria is Timecode Category, but this can be changed by replacing it with any other fields in the pivot table and the pie chart will dynamically change to reflect the selection.

This report is enabled by the associations in the databases described herein. In particular, the allocation of people to Workgroups associated with Lines of Business and the requirement for Timesheets for the people with the data being captured in the databases. It enables one to identify those Lines of Business that are performing well or poorly in terms of resource usage. By using other fields one can identify particular problem applicants, for example.

Again using notional RIS as an example, problematic applications can be identified based on the data in the configured databases. This example will first look at the resulting reports and then at additional details of the method by which data is configured in the databases to achieve these results. The configured databases will also be useful for other purposes.

Referring to FIG. 1 G, in order to provide the Application Portfolio Analysis features of the example, there are two key definitions for application hierarchy levels. There must be an application hierarchy level where Steering Committee & Top 10 is defined, and a hierarchy level where Tickets are allowed to be entered (highest level).

The hierarchy level for Steering Committee & Top 10 has to be higher or at the same level where Tickets are allowed to be entered (never lower). Links to Time247 workgroups can only be defined at the Steering Committee & Top 10 hierarchy level. Application importance and skillset properties can only be defined at the hierarchy level where tickets are allowed to be entered. Tickets can be allowed to be entered at a level to enforce that all lower levels also allow tickets to be entered.

This example contains an analysis for tickets meeting the flowing criteria:
Task Type: Data fix, Enhancement, Information Request, Problem.
Task Priority: Critical, High, Normal.
Application Importance: Critical, Important, Mission Critical, Vital.

The collection of tickets meeting the above criteria will be called “problematic tickets in this example.

Problematic Applications—Current

Referring to FIG. 6C, shown is a report of all outstanding (not resolved) problematic tickets. Applications are sorted by Importance and number of problematic tickets.

In this example, Benchmark Resolve=Expected Resolve Time specified in Benchmark. Blank means not specified. Time Spent to date=Actual Time spent to date trying to resolve these tickets-averaged over all unresolved tickets in group. Benchmark Resolve= . . . hours means the support model is 7×24 (7 days per week, 24 hours per day) where personnel are expected to be available night and day to respond to and work on requests. The Benchmark time to Respond/Resolve begins immediately the minute the Ticket is Received. There is no calendar.

Benchmark Resolve= . . . workhours means the support model is Support Hours where personnel are expected to be available normal working hours to respond to and work on requests. The Benchmark time to Respond/Resolve begins when the Ticket is received if it is received during work hours or the beginning of the next workday if it is received during non-working hours. A Time247 Calendar must be specified to identify the workdays and work hours. The Benchmark time does not measure time when personnel are not expected to be at work. For example, for an 8am to 5 pm Monday to Friday calendar, a Ticket received at 3pm Friday and responded to at 10am Monday has a response time of four hours (whereas in 7×24 it has a response time of 67 hours).

Benchmark Resolve = . . . workdays means the support model is Business Days where, as in workhours, personnel are expected to be available normal working hours to respond to and work on requests but the measurement of time is in days, not hours. The Benchmark time to Respond/Resolve begins on the day when the Ticket is received irrespective of the time of day it is received, Benchmark time to Respond/Resolve begins on the day when the Ticket is received irrespective of the time of day it is received, and counts the days till it is Responded/Resolved. A Ticket that is received and Responded/Resolved on the same day has zero days. A Time247 Calendar must be specified to identify the workdays. The Benchmark time does not measure days when personnel are not expected to be at work. For example, for an 8am to 5pm Monday to Friday calendar, a Ticket received at 3pm Friday and responded to at 10am Monday has a response time of one day.

Problematic Applications—Historic

Referring to FIG. 6D, shown is a report all Applications in the top 100 percentile (minimum five applications listed) based on the count of problematic tickets for the past 12-month period. The distribution of when the tickets were received is shown graphically by month showing the past 12 months. Applications are sorted by Importance and number of problematic tickets.

Problematic Applications—Benchmark Overage

Referring to FIG. 6E, shown is a report of all Applications in the top 100 percentile (minimum five applicants listed) based on Benchmark Overage—the number of missed benchmarks and the amount the benchmark was missed by. The distribution of Benchmark Overage occurrence is shown graphically by month for the last 12 months. The Benchmark Overage analysis includes both “Time to Respond” and “Time to Resolve”. In other words, tickets that are received and ignored count twice. Applications are sorted by Importance and Benchmark Overage.

In this example, Benchmark Overage is calculated as follows: For each benchmark missed, calculate the percentage the benchmark is over by, and then sum all of these percentages. For example, if a benchmark to resolve is 10 days and it took 11 days to resolve it (over by 10%) and this occurred three times, then the Benchmark Overage is 30.

Count is the number of occurrences of Benchmark Overage. Count % is the number of occurrences of Benchmark Overage/Total number of Tickets received. Average Overage is Benchmark Overage/Count.

Steering Committee Meetings—

Referring to FIG. 6F, a Steering Committee for each Line of Business can review outstanding tickets and set priorities for the tickets. Those tickets having a priority sufficient to merit resources are given a “Top 10” priority. It is to be recognized that there may be fewer or great tickets in the “Top 10”. A priority in the “Top 10” means only that work is authorized by the Steering Committee to be performed on that ticket. The Steering Committee is an authorization body for work to be performed on tickets. The results of the authorization body are captured in the configured databases such that a ticket authorized for work is so indicated. In FIG. 6F, authorization for RIS R&D tickets is simply indicated by ranking one ticket against another as shown in FIG. 6. Timesheet time is permitted to be entered against ranked tickets only. Time cannot be entered against unranked tickets. It is to be noted that the status of some tickets in FIG. 6D is “resolved” or “closed”. This is because this example is being viewed between authorizing body meetings and some tickets have been closed or resolved. Unmarked tickets are not shown.

Steering Committee Meeting can have the following standard decision making process:
Step 1. Review progress on the Opening Top 10, which were the Closing Top 10 from the last meeting. Agree on the Task Status of the Top 10 Tickets (Received, Responded, Resolved).
Step 2. Decide as a committee what to do with each Top 10 Ticket:
   The Ticket is resolved. Remove it from the Top 10 thereby providing space for new Top 10 candidates.
   The Ticket is not resolved. Leave it on the Top 10 List.
   The Ticket is not resolved. Move it into the Backlog thereby providing space for new Top 10 candidates.
Step 3. Review each New Ticket (unresolved tickets received since the last meeting) and decide whether to move it into a Top 10 position or to move it onto the Backlog.
Step 4. Ask if any Steering Committee Member wishes to bring forward any backlogged tickets onto the Top 10. The Backlog is not reviewed Ticket by Ticket.
Step 5. Review all Top 10 candidates and prioritize them 1, 2, 3 . . . If there are too many tickets, move some to the Backlog. If there are not enough bring some forward from the Backlog.
Step 6. The Solution Manager then identifies a date when most of the Top 10 will be complete and sets the next Steering Committee for that timeframe. Steering Committee Meetings are held only when there is significant progress on the Top 10.
Step 7. Track247 is updated with the Closing Top 10 and Closing Backlog list of Tickets.

In this example:
1—Meeting Date—date when the meeting took place (link to meeting documents and other details)
2—Backlog—unresolved tickets as of the beginning of the analysis period
3—New—unresolved tickets received during the analysis period
4—Top 10—opening Top 10 ticket count
5—Resolved tickets to be removed from Top 10—work done since the last meeting
6—Unresolved Top 10 tickets sent to backlog—SCM decided to remove some unresolved ticket from the Top 10
7—Backlog tickets promoted to Top 10—normal case of adding tickets to Top 10
8—New tickets promoted to Top 10—normal case of adding tickets to Top 10
9—Backlog—closing Backlog=(2)+(3)+(6)−(7)−(8)
10—Top 10—closing Top 10=(4)−(5)−(6)+(7)+(8)

Possible indication of back-door activity:
Case 1: Closing Backlog of a meeting does not match opening Backlog of next meeting. It means some tickets were resolved without being included in the Top 10 by the Steering Committee.
Case 2: Closing Top 10 of a meeting does not match opening Top 10 of the next meeting. It means tickets have been added to Top 10 outside the Steering Committee meeting. Unless the Steering Committee approved this later addition this is back-door activity.
Client Business Function: Services

Referring to FIGS. 6G-I, other reports useful in decision making can be provided by the system utilizing the configured databases.

Where:
Unresolved=Count of Tickets currently Unresolved
Resolved=Count of Tickets resolved in past 12 months
Timeframe=average time to resolve a ticket (not applicable to unresolved tickets)
Benchmark Resolved=Superb—95% Tickets within benchmark, Good—80% of Tickets within Benchmark, Fair—75% Tickets within Benchmark, Poor—50% Tickets within Benchmark, Bad—less than 50% Tickets within Benchmark. For the unresolved tickets the Benchmark shows that progress is on track for the mentioned rating as of Sep. 27, 2004.
Benchmark Unresolved=Superb—95% Tickets within benchmark, Good—80% of Tickets within Benchmark, Fair—75% Tickets within Benchmark, Poor—50% Tickets within Benchmark, Bad—less than 50% Tickets within Benchmark. For the unresolved tickets the Benchmark shows the rating if all tickets were currently closed.
Note: Benchmark rating will only be provided if at least 50% of the tickets have set targets. Otherwise it will show as N/A.
And where:
Benchmark Overage is calculated as follows: For each benchmark missed, calculate the percentage the benchmark is over by, and then sum all of these percentages. For example, if a benchmark to resolve is 10 days and it took 11 days to resolve it (over by 10%) and this occurred 3 times, then the Benchmark Overage is 30.
FTE (time) is from % Utilization report in Time247. It is all hours recorded on all staff timesheets (Billable plus Non-Billable) divided by the Expected Hours on the calendar.
% Utilization is timesheet Billable hours as a percent of Calendar Expected Hours averaged over all staff. These hours can be skewed—see Time247 % Utilization Report for details.
% Turnover is persons who left the headcount during the month/average headcount during the month. See Time247 turnover report for details.

FTE (ticket) is a FTE calculation based on “Actual Time” entered on tickets instead of timesheet recorded hours. It should not be considered accurate.
Benchmark Rating=Superb—95% Tickets within benchmark, Good—80% of Tickets within Benchmark, Fair—75% Tickets within Benchmark, Poor—50% Tickets within Benchmark, Bad—less than 50% Tickets within Benchmark Benchmark Overage is calculated as follows: For each benchmark missed, calculate the percentage the benchmark is over by, and then sum all of these percentages. For example, if a benchmark to resolve is 10 days and it took 11 days to resolve it (over by 1%) and this occurred 3 times, then the Benchmark Overage is 3.
Application Stability Ratio: Very Stable=1, very unstable=0. Calculation is based on problem count. If problem count for past 12 month is less than 11, then the Application Stability Ratio is 1. If the problem count for the past 12 month is greater than 11, then the Application Stability Ratio is 1/log (problem count).
Good Work−Bad Work Ratio=Percent of total time available spent on Good Work. For SML-2 this is an enhancement ticket count against total ticket count calculation.

The methods can implement benclunarking by converting localized information technology application services to worldwide standards for productivity comparison.

For example, the methods can store tickets that represent work requested of the workgroup for work on the application inventory. Work priorities for the tickets can also be stored in a database. The storage of ticket priorities can be a discrete (normally monthly) process required by the database and/or software. Although it is not required, this allows for a formal (as opposed to adhoc) priority setting process that is not changed mid-stream. Attempts to change priorities or enter time on non-authorized work can be the subject of a report produced using data from the databases.

Timesheets, representing work done, are stored in accordance with accounting methods and standards tracking and auditing costs and time. Time and cost recorded on timesheets (and reported using GAAP) against calendar time (time available for recording and reporting) and against time actually worked (recorded on individual tickets) can be audited. This provides a triple entry, 3-way balance check for audit so CEOs can be assured the accounting statements for ASM are accurate and complete. This is particularly important to ensure compliance with new legislative regimes, such as Sarbannes Oxley.

Many other ASM management reports can be generated from the data in the database and related software, including for example: headcount, turnover, % utilization, and problematic applications.

It will be understood by those skilled in the art that this description is made with reference to the preferred embodiment and that it is possible to make other embodiments employing the principles of the invention which fall within its spirit and scope as defined by the following claims.

I claim:

1. One or more databases for use in computer program application support and maintenance, the databases comprising:
a) an inventory of computer program applications of the organization (“application inventory”) wherein the application inventory is arranged in a multilevel hierarchy having descending levels, wherein a line of business level is a line of business within an organization that utilizes an application and the lines of business of an organization are logical divisions for business executives of the organization to utilize, an application level is an application name commonly used within the organization by users of the application, and a technical module level is a technical module of the application which is recognized by support and maintenance personnel for a line of business; wherein a support and maintenance work authorization and authorized workgroup are set at the line of business level, and requests for work are set at the application level and below, and
b) timesheets, each timesheet comprising time data recorded by a skilled person in a workgroup for work on a ticket.

2. The database of claim 1 wherein each Line of Business is a profit/cost center of the organization.

3. The database of claim 1 further comprising:
an inventory of skilled people (“skills inventory”) wherein the skilled people in the skills inventory are assigned into workgroups, and each workgroup is assigned to one or more lines of business.

4. The database of claim 3 further comprising:
a list of services that each workgroup is able to provide for its assigned one or more lines of business.

5. The database of claim 4 further comprising:
a service level and benchmark (target time to responded resolved each service) associated with each service.

6. The database of claim 5 further comprising:
a start date and an end date for each assignment of a skilled person to a workgroup.

7. The database of claim 6 further comprising:
tickets that are assigned to skilled people, wherein a ticket represents requested work on computer software of the organization as represented by its application name.

8. The database of claim 7 further comprising:
estimated time to complete work on a ticket and, if completed, actual time to complete the work.

9. The database of claim 6 further comprising:
tickets that represent requested work on computer software of the organization as represented by its application name.

10. The database of claim 9 further comprising:
a priority assigned to each ticket.

11. A computer system comprising the database of claim 10, wherein the system recognizes when time is entered by a person against a ticket that has a priority that does not permit the entry of time.

12. A computer system comprising the database of claim 11, wherein the system recognizes when time is entered by a person against a ticket to which the person has not been assigned.

13. One or more databases for use in computer program application support and maintenance for an organization, the databases comprising:
a plurality of records organized in a descending hierarchy of
a) a plurality of Line of Business records, each Line of Business record for a Line of Business recognized by the Board of Directors of the organization;
b) a plurality of application Black-Box records, each application Black-Box record for one of a plurality of application names that are recognized in the organization by users of computer software to which the application name refers, wherein each application Black-Box record is related to one or more Line of Business records; and
c) a plurality of technical module records, each technical module record for one of a plurality of technical modules recognized by application support and maintenance personnel for the organization, wherein each technical module record is related to one or more application Black-Box records.

14. The database of claim 13 wherein each Line of Business is a profit/cost center of the organization.

15. The database of claim 13 further comprising:
a plurality of skilled person records, each skilled person record for a person skilled in an aspect of application support and maintenance for the organization, wherein each skilled person is related to a workgroup for a Line of Business of the organization.

16. A computer-implemented method of supporting and maintaining computer program applications, the method comprising:
storing in one or more databases
a) an inventory of computer program applications of the organization (“application inventory”) wherein the application inventory is arranged in a multilevel hierarchy having at least three descending levels, wherein a Line of Business level is a Line of Business within the organization that utilizes an application, wherein the profit/cost of the Line of Business is recognized separately from other lines of business by the Board of Directors of the organization, an application level is an application name commonly used within the organization by users of the application, and a technical module level is a technical module of the application which is recognized by support and maintenance personnel for a line of business; wherein a support and maintenance work authorization and authorized workgroup are set at the line of business level, and requests for work are set at the application level and below, and
b) timesheets, each timesheet comprising time data recorded by a skilled person in a workgroup for work on a ticket.
